(19) United States
(12) Patent Application Publication
(10) Pub. No.: US 2026/0106693 A1
(43) Pub. Date: Apr. 16, 2026

(54) ERROR MITIGATION AND HANDLING IN INTERCONNECTED PROCESSING UNITS

(71) Applicant: Groq, Inc., San Jose, CA (US)

(72) Inventors: Benjamin Charles Serebrin, Sunnyvale, CA (US); Santosh Raghavan, Sunnyvale, CA (US)

(21) Appl. No.: 19/358,336

(22) Filed: Oct. 14, 2025

Related U.S. Application Data
(60) Provisional application No. 63/706,965, filed on Oct. 14, 2024.

(51) Int. Cl. H04L 1/00; G06F 12/0891; G06N 3/0475

(52) U.S. Cl. CPC H04L 1/0061; G06F 12/0891; G06N 3/0475; H04L 1/0008; H04L 1/0071

(57) ABSTRACT

Systems and methods described herein provide for: generating a deterministic processing schedule assigning a plurality of computation operations among a plurality of functional units, wherein the plurality of functional units are arranged among a plurality of processing units; receiving, by a first processing unit of the plurality of processing units, a packet from a second processing unit of the plurality of processing units; detecting an error in the packet; identifying, based on the deterministic processing schedule, an identified context of a plurality of contexts, the identified context associated with the packet; and altering a value of one or more poison bits in a poison register to indicate that the identified context is poisoned.

### CROSS-REFERENCE TO RELATED APPLICATIONS

The present application claims the benefit of priority of U.S. Provisional Patent Application No. 63/706,965, filed Oct. 14, 2024, the contents of which are incorporated herein by reference in the entirety.

### FIELD

The present disclosure relates generally to systems and methods for performing computing operations, such as machine-learning inference operations, such as error mitigation and handling in interconnected processing units.

### BACKGROUND

Machine learning is an artificial intelligence technique in which a computing device can “learn” from training data, such as training data obtained from a static training dataset or an interactive learning environment. For example, a computing system can obtain a training dataset; initialize a machine learning model comprising a plurality of parameters (e.g., untrained parameters such as randomly generated starting parameters, etc.); and train the parameters based on the training dataset. The trained machine-learning model can then be used to perform various operations, such as prediction operations, generative artificial intelligence operations (e.g., language generation, image generation, audio generation, video generation, etc.), automation operations (e.g., hardware automation such as robot or automobile automation, software automation such as web browser or user interface automation, etc.), reasoning operations, agentic operations, or other machine learning operations. Operations performed by a trained machine-learning model can be referred to as machine-learning inference operations.

### SUMMARY

Aspects and advantages of embodiments of the present disclosure will be set forth in part in the following description, or can be learned from the description, or can be learned through practice of the embodiments.

In an aspect, the present disclosure provides a method for error correction in chip-to-chip (C2C) communications for a processor. The method includes generating a deterministic processing schedule assigning a plurality of computation operations among a plurality of functional units, wherein the plurality of functional units are arranged among a plurality of processing units. Additionally and/or alternatively, the method includes receiving, by a first processing unit of the plurality of processing units, a packet from a second processing unit of the plurality of processing units. Additionally and/or alternatively, the method includes detecting an error in the packet. Additionally and/or alternatively, the method includes identifying, based on the deterministic processing schedule, an identified context of a plurality of contexts, the identified context associated with the packet. Additionally and/or alternatively, the method includes altering a value of one or more poison bits in a poison register to indicate that the identified context is poisoned.

In an aspect, the present disclosure provides a system. The system includes a plurality of functional units arranged among a plurality of processing units. Additionally and/or alternatively, the system includes a poison register. Additionally and/or alternatively, the system includes one or more processors. Additionally and/or alternatively, the system includes one or more computer-readable media storing instructions that, when executed, cause the one or more processors to perform operations. Additionally and/or alternatively, the operations include generating a deterministic processing schedule assigning a plurality of computation operations among the plurality of functional units. Additionally and/or alternatively, the operations include receiving, by a first processing unit of the plurality of processing units, a packet from a second processing unit of the plurality of processing units. Additionally and/or alternatively, the operations include detecting an error in the packet. Additionally and/or alternatively, the operations include identifying, based on the deterministic processing schedule, an identified context of a plurality of contexts, the identified context associated with the packet. Additionally and/or alternatively, the operations include altering a value of one or more poison bits in the poison register to indicate that the identified context is poisoned.

In an aspect, the present disclosure provides a method. The method includes generating characterization data for a C2C communication link of a system including a plurality of processing units and a plurality of functional units, the C2C communication link coupling at least two of the plurality of processing units. Additionally and/or alternatively, the method includes generating a deterministic processing schedule assigning a plurality of computation operations among the plurality of functional units. Additionally and/or alternatively, the method includes identifying, based on the deterministic processing schedule, a data transfer operation of the plurality of computation operations, the data transfer operation occurring along the C2C link. Additionally and/or alternatively, the method includes, based on the characterization data, assigning an error correction scheme of a plurality of candidate error correction schemes to be applied to the data transfer operation in the deterministic processing schedule.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 is a block diagram of an example multiunit system according to example implementations of aspects of the present disclosure.

FIG. 2 is a block diagram of an example multiunit system according to example implementations of aspects of the present disclosure.

FIGS. 3A-3C are block diagrams of an example interleaving schema according to example implementations of aspects of the present disclosure.

FIG. 4 is a block diagram of an example plot of latency against burstiness of a communications link.

FIG. 5 is a block diagram of an example packet padding schema according to example implementations of the present disclosure.

FIG. 6 is a block diagram of an example multiunit system according to example implementations of the present disclosure.

FIG. 7 is a flowchart diagram of an example method for error handling and mitigation in a multiunit system according to example implementations of the present disclosure.

FIG. 8 is a block diagram of an example processor device according to example implementations of aspects of the present disclosure;

FIG. 9 is a block diagram of an example processor device according to example implementations of aspects of the present disclosure;

FIG. 10 is a block diagram of an example tensor streaming processor device according to example implementations of aspects of the present disclosure;

FIG. 11 is a block diagram of an example computing node according to example implementations of aspects of the present disclosure;

FIG. 12 is a block diagram of an example multi-node computing system according to example implementations of aspects of the present disclosure;

FIG. 13 is a block diagram of an example multi-node computing system according to example implementations of aspects of the present disclosure;

FIG. 14 is a block diagram of an example system for compiling a machine-learning model according to example implementations of aspects of the present disclosure.

### DETAILED DESCRIPTION

Example embodiments according to some aspects of the present disclosure are directed to systems and methods for error mitigation and handling in interconnected processing units. Large-scale computing systems, such as those designed for complex tasks like machine-learned inference, can rely on numerous interconnected processing units communicating over high-speed links. These communication channels, however, are susceptible to data transmission errors. Conventional error recovery methods may be limited in ability to correct errors beyond a certain severity. In cases where errors cannot be corrected, some existing systems may discard the results of an entire processing cycle, including data that may otherwise be unaffected. This approach can be inefficient due to discarding otherwise usable data, introducing significant latency associated with system resets, and/or disrupting service for multiple users in a shared environment. Furthermore, standard error correction techniques may impose performance penalties, such as when a powerful, high-latency code is unnecessarily applied to a reliable link or when bandwidth is wasted transmitting padding for fixed-size data blocks.

To address these challenges, the disclosed systems and methods provide a fine-grained error handling architecture that leverages a deterministic processing schedule. Unlike non-deterministic systems, this architecture can operate on a pre-compiled deterministic processing schedule that precisely assigns computational operations to be performed by known functional units, and/or at known times or processing cycles. This degree of predictability can provide a foundation for a more intelligent error recovery process. For instance, by knowing exactly what data is expected where and when, the system can precisely isolate faults to specific computational tasks, or “contexts,” thereby avoiding the need for disruptive, system-wide interventions.

One approach to targeted fault isolation according to example aspects of the present disclosure involves using the deterministic schedule's timing data to identify a context associated with a detected uncorrected error. For instance, when a processing unit receives a data packet and detects an uncorrectable error through methods such as an invalid checksum, a skipped sequence number, or a failed Forward Error Correction (FEC) check, the processing unit can reference the deterministic processing schedule. Based on a comparison of a time or cycle at which a packet is received and the timing data indicating which context is associated with an expected packet at the time or cycle, the system can determine which of the contexts the corrupted packet belongs to. Furthermore, in some cases, this approach can avoid utilizing the contents of the packet itself, which may be corrupted. Once the affected context is identified, the system alters a “poison bit” in a dedicated hardware register, flagging the identified context as corrupted. The data associated with the affected context can be discarded or rewound while computation operations associated with other contexts can proceed uninterrupted.

Thus, poisoning a single context provides a highly efficient and resilient recovery strategy. After the poison bit is set, the system continues to execute all operations for other, healthy contexts without interruption, ensuring that progress on unaffected tasks is not lost. Concurrently, a targeted recovery can be initiated for only the poisoned context, which may involve, for instance, re-executing the specific failed computation. For stateful applications, such as large language models, this may also include resetting a relevant program cache, such as a LLM cache or other cache utilized by a machine-learning model (e.g., a key-value (KV) cache), to a known-good state before the operation is repeated. This approach contains the impact of a single communication failure, significantly improving system throughput and fault tolerance.

In addition to and/or alternatively to the targeted recovery approach described above, the present disclosure provides for additional communication optimizations that enhance performance and/or data integrity. For instance, in some implementations, to mitigate the effect of burst errors that can overwhelm error correction codes, data symbols can be interleaved across multiple communication links prior to transmission. This process can provide for distributing consecutive symbols across a larger temporal area of a transmission such that a burst of noise on one link manifests as multiple, more easily correctable single-symbol errors at the receiver.

Furthermore, the approaches described herein can improve bandwidth efficiency for error correction schemes that operate on fixed-size data blocks. According to example aspects of the present disclosure, instead of transmitting a small data packet padded with non-substantive data, the transmitting unit can transmit only the unpadded packet. The receiving unit, knowing the required block size from the deterministic processing schedule, can append the default values after reception for error correction. The aforementioned receiver-side padding can reduce the amount of data transmitted over the link, which can provide for conserving bandwidth, lower power consumption, and/or reducing overall communication latency.

Aspects of the present disclosure provide a number of technical effects and benefits, including improvements to computing technology by addressing challenges related to data corruption in large-scale, distributed computing systems. In some existing systems, a response to an uncorrectable communication error may involve a coarse-grained recovery mechanism, such as halting the entire computational pipeline. This approach can be inefficient, as it can involve discarding the valid work of all processing units and increases latency. The present disclosure provides a fine-grained error isolation and recovery method by leveraging a deterministic processing schedule. This schedule allows the system to identify the specific computational context associated with a corrupted data packet based on timing information. Rather than halting all operations, the system may instead alter one or more poison bits in a hardware poison register corresponding to the identified context. This can provide for improving system fault tolerance and throughput by isolating the error to a single context, which permits the system to continue executing computations for other, non-poisoned contexts while repeating operations only for the context affected by the error.

Additionally and/or alternatively, the present disclosure can provide for technical effects and benefits including improving the efficiency and performance of the communication links themselves. To mitigate the effect of wasted bandwidth from transmitting padding data for fixed-size error correction codewords, the present disclosure provides for a transmitter to send a shorter, unpadded data packet. The receiver, informed by the deterministic schedule of the expected packet structure, can locally append default values to reconstruct a full codeword for error correction before decoding. This reduces transmission latency and increases effective bandwidth. Additionally, the present disclosure provides for utilizing a deterministic processing schedule to implement an adaptive, link-specific error correction strategy based on pre-characterized the transmission properties of each communication link. Based on this pre-characterization information, the system can select an appropriate error-mitigation technique at compile-time, such as low-latency interleaving and/or relatively simpler Error Correcting Codes (ECC) for reliable links and more robust Forward Error Correction (FEC) for noisier ones, thereby optimizing the balance between performance and data integrity across the entire system.

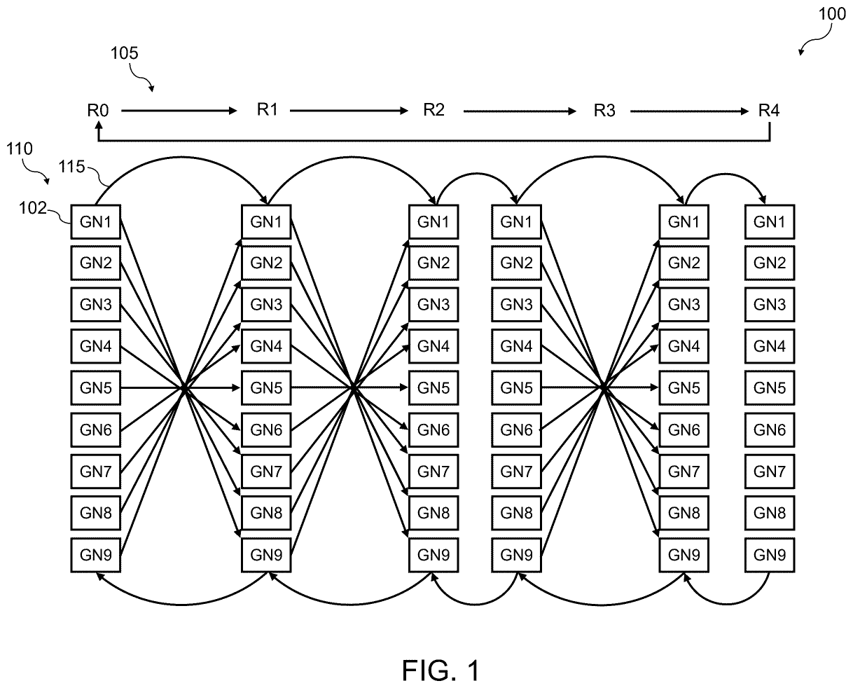

FIG. 1 is a block diagram of an example multi-unit system 100 according to example implementations of aspects of the present disclosure. The system 100 represents a large-scale computational architecture for performing distributed computing operations, such as inference tasks. The system 100 includes a cluster of processing racks 110, individually labeled as R0, R1, R2, R3, and R4, which each contain a plurality of nodes 102 (labeled GN1 through GN9). These nodes 102 can be, for example, language processing units (LPUs) that perform distributed computational tasks. Although five racks each having nine processing units are illustrated in FIG. 1, it should be understood that more or fewer racks and/or processing units may be included in a multi-unit system without departing from the scope of the present disclosure.

The system 100 provides for a large inference task or other computational job to be performed iteratively as data flows through the system 100. For example, data can be processed by the nodes 102 in one rack 110 (e.g., R0), with the intermediate results then passed to the next rack 110 (e.g., R1) for the subsequent stage of the computation. This process can continue sequentially across the racks 110 (e.g., R2, R3, R4), creating a deep, multi-rack processing pipeline where each rack 110 contributes to a portion of the overall task.

The nodes 102 can be interconnected by communication links 115, otherwise referred to as “chip-to-chip” or C2C communication links. The C2C links can facilitate the significant data transfers involved in large-scale computation. For instance, in some implementations, the data rates of C2C links 115 may be on the order of tens to hundreds of gigabits (Gb) per second or greater, such as about 50 to 150 Gb per second or greater. The communication over these high-speed links can be prone to errors, which the systems and methods of the present disclosure are designed to mitigate.

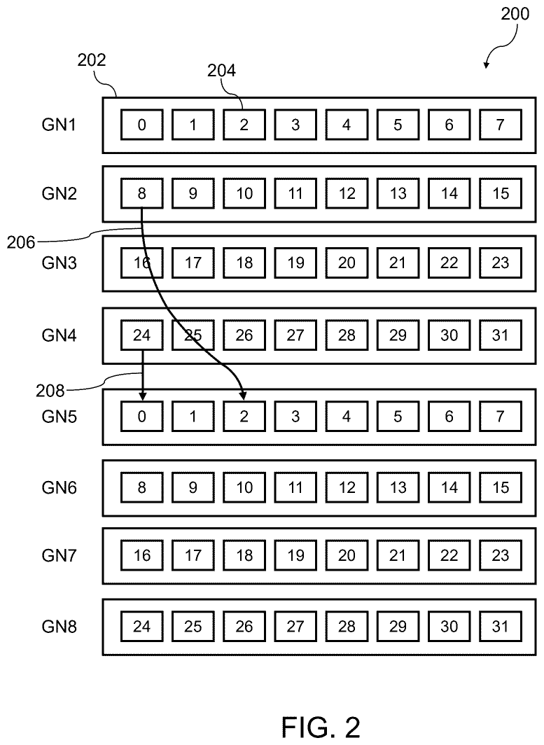

FIG. 2 is a block diagram of an example multi-unit system 200, illustrating data transfer within a rack of processing systems. The system 200 includes multiple nodes 202, labeled GN1 through GN8. Although nine nodes 202 are illustrated in the system 200 of FIG. 2, it should be understood that more or fewer nodes 202 may be included in a system 200 without departing from the scope of the present disclosure. Each node 202 includes a plurality of processing units 204. The processing units 204 can, for example, be a processor, such as a language processing unit (LPU).

As illustrated, a system 200 can include various types of intra-rack data connections. For example, C2C link 206 depicts a longer data transfer path between non-adjacent nodes (from a unit in GN2 to a unit in GN5). In contrast, C2C link 208 depicts a shorter data transfer path between adjacent nodes (from a unit in GN4 to a unit in GN5). Longer communication links such as the C2C link 206 may be generally more susceptible to noise and burst errors than shorter links such as the C2C link 208.

As will be explained further herein, a computing system according to the present disclosure can leverage its deterministic nature to apply different error correction schemas based on the pre-characterized quality of each link. For instance, a more robust but higher-latency Forward Error Correction (FEC) scheme may be selected for a noisier link such as the C2C link 206, while a lower-latency Error-Correcting Code (ECC), potentially combined with interleaving, may be selected for a more reliable link such as the C2C link 208 to optimize for performance while ensuring data integrity.

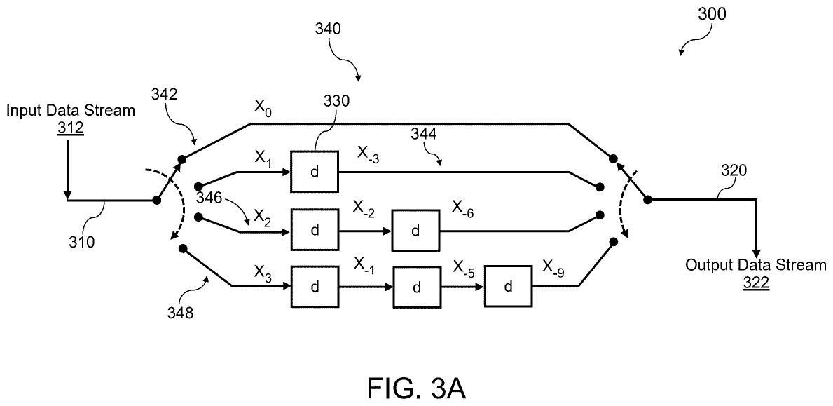

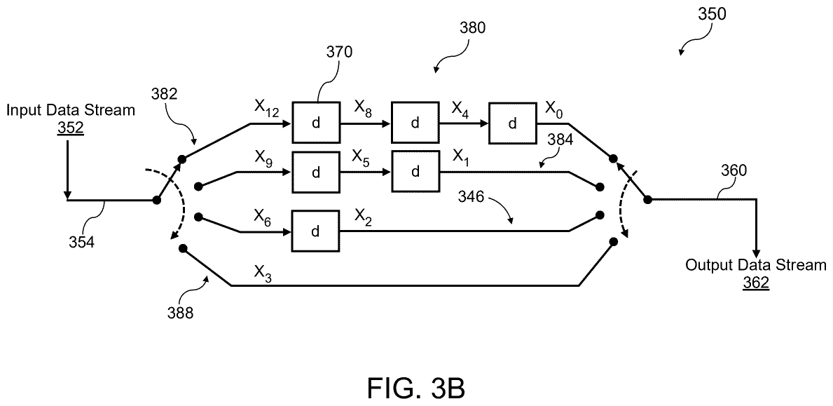

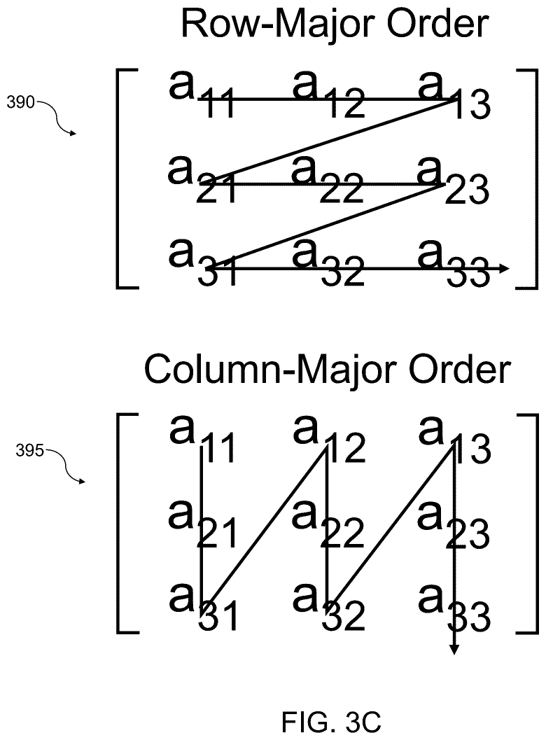

FIGS. 3A through 3C depict block diagrams of an example interleaving schema according to example aspects of the present disclosure. In particular, FIG. 3A depicts a block diagram of an interleaver 300 according to example aspects of the present disclosure. The interleaver 300 can be configured to receive an input data stream 312 and produce a reordered output data stream 322. The input data stream 312 can, for instance, be data, such as a packet of data, that is to be transmitted along a C2C communication link. The output data stream 322 can, for instance, be reordered for transmission along the C2C communication link. Thus, for instance, the interleaver 300 may be incorporated into a C2C communication module to interleave data prior to transmission along a C2C communication link. The interleaver 300 may additionally and/or alternatively be a standalone component of a processing unit.

The interleaver 300 can include an input port 310 that receives the input data stream 312. The input data stream 312 can be represented as a sequence of one or more symbols corresponding to, for example, character values, bytes, or other suitable division of data. As one example, the symbols can be selected from a vocabulary of a machine-learning model (e.g., a large language model) used for an inference task. Additionally and/or alternatively, in some implementations, the symbols may be disjoint from a vocabulary of a machine-learning model. For instance, the symbols may be defined by physical layer units, such as flits or ten-bit symbols. A symbol may be represented as xᵢ, where i corresponds to a position of the symbol in the input data stream 312. For example, a symbol at a base position may be represented as x₀, whereas an immediately preceding symbol may be represented as x₋₁ and an immediately following symbol may be represented as x₁.

The input data stream 312 can be processed using a reordering logic or reordering circuit to reorder the symbols into a different ordering, as output data stream 322, which is conceptually illustrated as a plurality of parallel processing paths 340. These paths include a first path 342, a second path 344, and a third path 346, and a fourth path 348. Although four paths are illustrated in FIG. 3A, it should be understood that more or fewer paths may be included in an interleaver without departing from the scope of the present disclosure. The symbols may be incrementally passed along each of the processing paths 340. For example, a first symbol x₀ may be passed along the first path 342, a second symbol x₁ may be passed along the second path 344, and so on.

One or more delay elements 330 can be arranged along at least some of the processing paths 340. The delay elements 330 impart a delay (represented by d) on the symbols passed along a respective processing path 340. Each delay element 330 stores a data symbol for a predetermined time interval before passing the symbol further along the path 340. The delay elements 330 may therefore alter the temporal sequence of the data. For instance, in the example of FIG. 3A, the delay elements may delay the symbol by an amount of time equal to four positions in the data stream. For instance, a symbol passed along the first path 342, which lacks a delay element 330, may be passed to the output data stream 322 without altering its position. A symbol passed along the second path 344, which includes one delay element 330, may be delayed by four positions. A symbol passed along the third path 346, which includes two delay elements 330, may be delayed by eight positions. A symbol passed along the third path 348, which includes three delay elements, may be delayed by twelve positions.

By writing symbols into this structure and reading them out in a different order, the interleaver 300 generates a permuted output data stream 322. For instance, in the example of FIG. 3A, an input data stream 312 represented by . . . x₀, x₁, x₂, x₃ . . . can be converted to an output data stream 322 represented by . . . x₀, x₋₃, x₋₆, x₋₉, x₄, x₋₂, x₋₅ . . . . This output data stream 322 can be transmitted from an output port 320. The reordering of symbols serves to convert potential burst errors into more manageable errors for subsequent error correction stages, such as per-symbol error correction codes (ECC). For instance, a burst error affecting two consecutive symbols may instead be distributed among two disparate symbols, which can be easier for some error correction algorithms to correct. The interleaved data can be processed by a deinterleaver to restore the input data stream 312 from the output data stream 322.

FIG. 3B depicts a block diagram of an example deinterleaver 350 according to example aspects of the present disclosure. Similar to the interleaver 300 of FIG. 3A, the deinterleaver 350 can be configured to receive an input data stream 352 and produce a reordered output data stream 362. The input data stream 352 can, for instance, be data, such as a packet of data, that has been transmitted along a C2C communication link. For instance, the input data stream 352 may be the output data stream 322 from the interleaver 300, subsequent to transmission along a C2C communication link. The output data stream 362 can, for instance, be similar or identical to the input data stream 312 of the interleaver 300.

The deinterleaver 350 can include an input port 354 that receives the input data stream 352. The input data stream 352 can be represented as a sequence of one or more symbols corresponding to, for example, character values, bytes, or other suitable division of data. As one example, the symbols can be selected from a vocabulary of a machine-learning model (e.g., a large language model) used for an inference task. Additionally and/or alternatively, in some implementations, the symbols may be disjoint from a vocabulary of a machine-learning model. For instance, the symbols may be defined by physical layer units, such as flits or ten-bit symbols. For the purpose of illustration, in the example of FIG. 3B, a symbol may be represented as xᵢ, where i corresponds to a position of the symbol in the output data stream 362 (or the pre-interleaved input data stream 312 of FIG. 3A). For example, a symbol at a base position may be represented as x₀, whereas an immediately preceding symbol may be represented as x₋₁ and an immediately following symbol may be represented as x₁.

The input data stream 352 can be processed using a reordering logic or reordering circuit to reorder the symbols into a different ordering, as output data stream 362, which is conceptually illustrated as a plurality of parallel processing paths 380. These paths include a first path 382, a second path 384, and a third path 386, and a fourth path 388. Although four paths are illustrated in FIG. 3B, it should be understood that more or fewer paths may be included in an interleaver without departing from the scope of the present disclosure. The symbols may be incrementally passed along each of the processing paths 380. For example, a first symbol x₁₂ may be passed along the first path 382, a second symbol x₉ may be passed along the second path 384, and so on.

One or more delay elements 370 can be arranged along at least some of the processing paths 380. The delay elements 370 impart a delay (represented by d) on the symbols passed along a respective processing path 380. Each delay element 370 stores a data symbol for a predetermined time interval before passing the symbol further along the path 380. The delay elements 370 may therefore alter the temporal sequence of the data. For instance, in the example of FIG. 3B, the delay elements may delay the symbol by an amount of time equal to four positions in the data stream. For instance, a symbol passed along the fourth path 388, which lacks a delay element 370, may be passed to the output data stream 362 without altering its position. A symbol passed along the third path 386, which includes one delay element 370, may be delayed by four positions. A symbol passed along the second path 384, which includes two delay elements 370, may be delayed by eight positions. A symbol passed along the first path 382, which includes three delay elements, may be delayed by twelve positions. As illustrated, the configuration of respective paths may be inverted between the interleaver 300 and the deinterleaver 350, such that a total number of delay elements 330 and 370 are consistent irrespective of the path taken by a given symbol. However, the amount of delay elements 330/370 experienced at the interleaver 300 and at the deinterleaver 350 is determined based on the selected path.

By writing symbols into this structure and reading them out in a different order, the deinterleaver 350 generates a permuted output data stream 362. For instance, in the example of FIG. 3B, an input data stream 352 represented by . . . x₀, x₋₃, x₋₆, x₋₉, x₄, x₋₂, x₋₅ . . . can be converted to an output data stream 362 represented by . . . x₀, x₁, x₂, x₃ . . . . This output data stream 362 can be transmitted from an output port 360 for subsequent processing. For instance, the output data stream 362 can include symbols for an inference task (e.g., by a machine-learning model or models) and may be processed by one or more functional units on a chip receiving the output data stream 362 to perform the inference task, or at least a portion of the inference task.

FIG. 3C illustrates an example interleaving schema according to example implementations of the present disclosure. In particular, FIG. 3C illustrates a conceptual diagram illustrating the principle of block interleaving using row-major and column-major data ordering to mitigate burst errors. The process of interleaving, such as that performed by the interleaver 300 of FIG. 3A, can be modeled by writing data, as illustrated by diagram 390, into a conceptual memory array (e.g., a data matrix) in one order and reading the data out, as illustrated by diagram 395, in a different order. In particular, the diagrams 390 and 395 illustrate data interleaving using a three-by-three data matrix including nine symbols denoted a_{xy}, where x is a row position and y is a column position. It should be understood that more or fewer than nine symbols may be interleaved without departing from the scope of the present disclosure.

In particular, the diagram 390 illustrates data being stored in row-major order, where data elements are stored sequentially along each row (e.g., a₁₁, a₁₂, a₁₃, a₂₁, a₂₂, a₂₃, a₃₁, a₃₂, a₃₃). The diagram 395 illustrates data being interleaved in column-major order, where data elements are accessed sequentially down each column (e.g., a₁₁, a₂₁, a₃₁, a₁₂, a₂₂, a₃₂, a₁₃, a₂₃, a₃₃). For instance, in one example interleaving operation, an incoming data stream, such as the input data stream 312 of FIG. 3A, is written into the data matrix in row-major order. The data is then read out for transmission (e.g., as output data stream 322 of FIG. 3A) in column-major order. This reordering separates symbols that were originally adjacent. For example, symbols a₁₂ and a₁₃ are adjacent in the input stream but are separated by several other symbols in the interleaved stream. To deinterleave the interleaved stream, this technique can be inverted. For instance, data can be written into a matrix in column-major order and read out in row-major order.

This technique can be effective in mitigating the effect of burst errors, which can corrupt several consecutive symbols during transmission. For instance, after the deinterleaver 350 of FIG. 3B performs the inverse operation (e.g., writing the received data into the matrix in column-major order and reading it out in row-major order), the errors from the burst are spread out and appear as multiple, correctable single-symbol errors rather than an uncorrectable block of corrupted data. This improves the overall error-correction capability and reliability of the C2C communication link. Furthermore, lower-resource error correction algorithms can be utilized with interleaving, such as over shorter communication links, to improve robustness of the links without requiring additional resources for significant error correction.

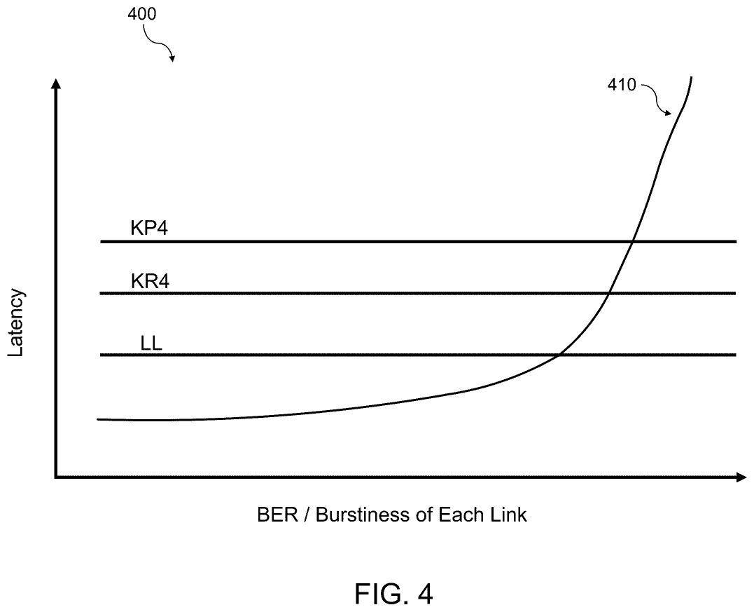

FIG. 4 depicts a plot 400 illustrating the relationship between data transmission latency and the quality of a communication link, according to example aspects of the present disclosure. The vertical axis represents latency and the horizontal axis represents the Bit Error Rate (BER), or the “burstiness” of errors on the link.

The curve 410 demonstrates that as link quality degrades and the rate of burst errors increases (moving to the right on the horizontal axis), stronger error correction methods are needed, which can introduce higher latency. The plot shows several horizontal lines corresponding to different standard Forward Error Correction (FEC) schemes, such as KP4, KR4, and LL, each providing a fixed trade-off between error correction strength and latency. For example, a very noisy or bursty link may traditionally involve the use of a high-latency code like KP4 to ensure the capability of correcting enough bit errors to preserve data integrity. While one approach may be to use the strongest FEC scheme necessary to preserve data integrity, the extra latency can be undesirable, and the capability of the strongest FEC scheme may not be necessary for all transmissions.

However, the deterministic nature of the tensor processors described herein can provide for performance of each C2C link to be pre-characterized at compile time. This knowledge enables the system to select the most efficient error mitigation strategy for a given C2C link. For example, at compile time, computing operations for performing a task (e.g., an inference task) can be assigned among a plurality of functional units on different processing units (e.g., language processing units), which may be on different physical substrates or “chips.” Because the order of functional units that will process a given set of data is known, the C2C links used to transmit the data between those functional units can additionally be known. Thus, based on the pre-characterization of the C2C links, the system can select, for each C2C link, an error correction scheme from a plurality of candidate error correction schemes to apply for the C2C link. As one example, for a shorter C2C link with a relatively lower level of burstiness, the system may apply a lower-latency error correction approach such as ECC with interleaving to operate at a lower latency while maintaining data integrity.

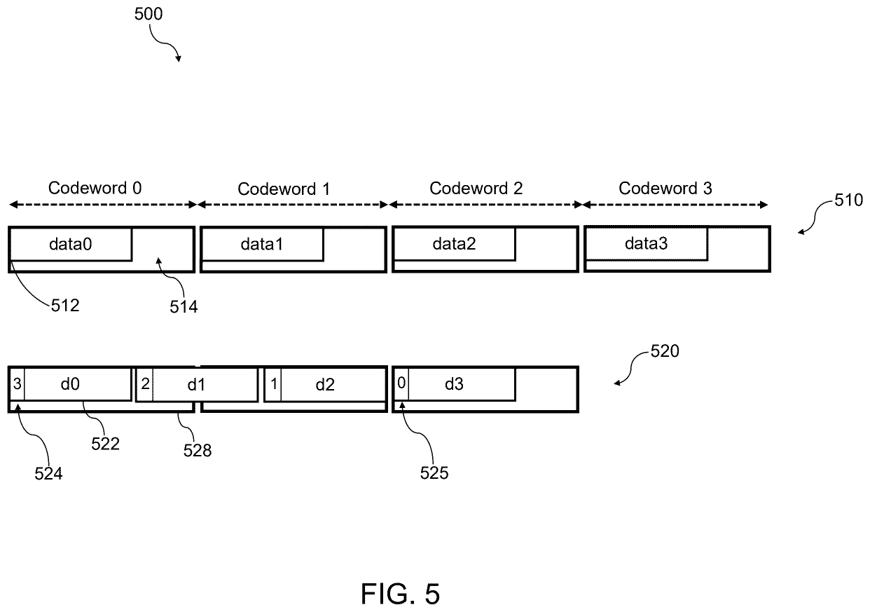

FIG. 5 is a diagram 500 that illustrates an approach for reducing latency and improving bandwidth efficiency for C2C communication links. Many error correction schemes, such as but not limited to Forward Error Correction (FEC), can operate on fixed-size data blocks called codewords. It is often desirable or even necessary to synchronize the length of a received data packet with the size of an error correction codeword to provide for proper detection of errors in the data packet. When a data packet is smaller than the data portion of the FEC codeword, the remainder is often filled with a known pattern, such as padding zeros. The padding zeros would be transmitted over the C2C link, consuming bandwidth and increasing latency for data that is otherwise unutilized.

The present disclosure, however, provides for utilizing the deterministic nature of the tensor processors described herein communicating over a C2C link, where a receiver has foreknowledge of the structure of a given transmission. In particular, during compilation of a program into a deterministic processing schedule, the size of each transmitted packet may be precomputed and provided to C2C link modules directly. Furthermore, information relating to the structure of a given transmission may not be encoded within the packet itself. This can provide for the padding zeros to be omitted at the transmitter and appended at the receiver prior to error correction based on the precomputed transmission structure information from the compiler. This can further provide that the packet will be the same length as the error correction codeword before decoding, without requiring that the transmission structure information be encoded into the transmission itself. The transmission structure information may therefore not be subject to noise in the communication link, and/or may decrease the amount of data over which error correction is performed.

The upper diagram 510 illustrates a packet of data 512 padded with one or more padding values 514. The data 512 may be meaningful data, such as intermediate outputs of a computational operation such as an inference task. The padding values 514 may be repeated zero values, one values, or other predictable pattern of values that are added to cause the length of each packet to be equal to that of an error correction codeword. As illustrated, a significant amount of transmission length may be attributable to the padding values 514.

Furthermore, in some conventional implementations, some error correction algorithms such as Forward Error Correction are invoked after complete reception of a transmission before error corrections are made. Some serializer/deserializer (SerDes) designs, especially those operating with noisy transmission paths, may enhance error correction performance by transmitting a predetermined number of data symbols, and then transmitting a known non-data pattern (e.g., all zeroes). This approach can provide for a greater correction amount per transmitted bit and/or greater code overhead per transmitted bit, without significant impact on latency.

In a deterministic system, the transmitting SerDes device can be informed that it is sending a padded message and/or the receiving SerDes device can be informed that it is receiving a padded message. The receiving SerDes device can thus perform error correction on a codeword using the data 512 and appending the padding values 514 at receiver-side, without waiting for the complete transmission of the padding values 514, because the values of the padding values are known. This can provide for an appreciable reduction in latency without decreasing data fidelity.

The lower diagram 520 illustrates a more efficient method for sending a sequence of back-to-back data packets. In the diagram 520, the data 522 is transmitted sequentially, without any padding values 514 as in the upper diagram 510. In the example of FIG. 5, a header packet 524 provides information on a number of consecutive packets. When the value of header packet 524 is nonzero, no padding values may be appended. However, when the value of a header packet 524 is zero (as in the case of final header packet 525), the FEC decoder can recognize that no subsequent packets will be provided in this transmission and append padding values to fill out the remaining error correction codeword 528. As illustrated, some data 522, such as the packet “d1,” may be split among multiple codewords 528. Alternatively, in some implementations, the header packets 524 may be omitted, and the information from the header packets 524 may instead be communicated from a controller, such as an instruction control unit, directly to a processing unit to avoid noise and/or wasted computing resources on the header packets 524.

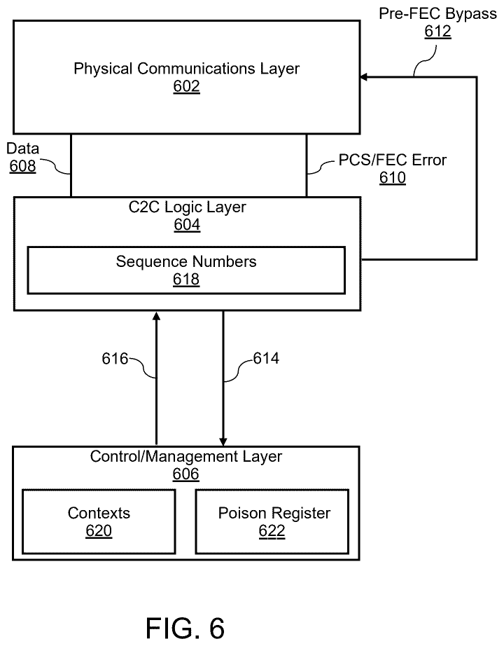

FIG. 6 is a detailed block diagram of an example system 600 according to example implementations of the present disclosure. The system 600 provides a multi-layered architecture for detecting, reporting, and isolating errors to improve the resilience of a deterministic multi-processor system. The architecture comprises a physical communications layer 602, a C2C logic layer 604, and a control and management layer 606, which interact to provide robust, fine-grained error handling.

The physical communications layer 602 can, for example, be a serializer/deserializer component. This component can be responsible for the serialization and deserialization of data for transmission and reception over a physical medium. In some embodiments, the physical communications layer 602 includes hardware for Forward Error Correction (FEC), such as LL, KP, or KR FEC schemes, which can be selectively enabled. If the FEC logic detects an uncorrectable error in a received codeword, the physical communications layer 602 asserts a PCS/FEC Error signal 610 to the C2C logic layer 604. The C2C logic layer 604 can be responsible for packet-level integrity and receives a data stream 608 from the physical communications layer 602. The transmitter of the data stream 608 can precompute a checksum, which can later be verified by the receiver of the data stream 608. The C2C logic layer 604 can utilize a plurality of mechanisms to ensure data integrity. At receive time, the C2C logic layer 604 can implement robust checksumming, calculating a checksum (e.g., a cyclic redundancy check or CRC) over an entire packet and marking the packet as “poisoned” if a mismatch occurs. This checksum can be applied to the raw data without consideration of any error correction bits, providing for the checksum to detect errors that may remain even after correction occurs. Additionally and/or alternatively, the C2C logic layer 604 can verify that sequence numbers 618 of received packets are received in sequential order. For instance, in some implementations, each packet type (e.g., Data, Notify, CSR) can be associated with a distinct sequence number that is monotonically increased by the transmitter. The C2C logic layer 604 at the receiver checks for skipped sequence numbers to detect dropped packets, which might not be caught by checksums alone.

A control and management layer 606 can include components responsible for controlling the C2C communications such as, for example, an Instruction Control Unit (ICU). The control and management layer 606 can be responsible for higher-level error tracking and recovery. The control and management layer 606 can, for instance, track a plurality of contexts 620 (e.g., eight contexts). The contexts 620 can provide for the system 600 to associate individual packets and/or any errors associated with those packets with specific and distinct computational streams or tasks, such as tasks associated with particular users. For each context 620, the control and management layer 606 can maintain status information, such as a “poison bit” indicating whether data associated with that context has been corrupted. For example, a poison register 622 can be provided at the control and management layer 606, in some implementations. The control and management layer 606 may also maintain counters for correctable and uncorrectable errors for diagnostic purposes.

As used herein, a poison bit refers to a status indicator that represents the poisoned state of a specific computational entity, such as a context or a data stream. This indicator, which may be a single bit or another data value, can be altered to flag that the associated entity (e.g., a particular context, as indicated by a context ID, position within the poison register 622, etc.) has been affected by an error and its data is considered corrupted or invalid in the present and/or subsequent computation operations. Setting the poison bit can provide a persistent record of a fault tied to a specific context. This can provide for the system 600 to identify the corrupted data and initiate a targeted action, such as re-executing a small portion of a computation associated with the context. Additionally, a poison register 622 refers to a memory or storage component, such as a hardware register, configured to store a plurality of poison bits. The poison register 622 can thus maintain status information for multiple contexts 620 in parallel, with each poison bit in the poison register 622 corresponding to a specific computational context. The poison register 622 can therefore provide a dedicated location for the system 600 to set, clear, query and/or otherwise manipulate the error state of each distinct computational stream, providing for fine-grained fault management and recovery. Furthermore, in some implementations, data in the poison register 622 (e.g., the poison bits) may be communicated from one processing unit to another processing unit as instructed by the control/management layer 606.

Additionally and/or alternatively, in some embodiments, system latency may be reduced by disabling FEC and using a different error correction scheme implemented within the C2C logic (e.g., the interleaved schema described above). For this purpose, a Pre-FEC Bypass path 612 can provide a raw, pre-transcoder data stream directly from the physical communications layer 602 to the C2C logic layer 604 for processing.

The layers including the C2C logic layer 604 and the control and management layer 606 can interact through specific control signals. For example, if the C2C logic layer 604 receives a packet, the control and management layer 606 can provide an associated Tracker Context ID on signal path 616. Additionally and/or alternatively, if the C2C logic layer 604 detects an error with that packet (e.g., a CRC mismatch or sequence number skip), the C2C logic layer 604 can report the error to the control and management layer 606 via signal path 614. This reporting signal can include the tracker ID and flags indicating if the error was corrected or uncorrected. The control and management layer 606 may then update the internal state for that context, such as by setting a poison bit associated with that context, in the case that an uncorrected error is detected. The control and management layer 606 can also issue commands back to the C2C logic layer 604 via signal path 616, such as, for example, an instruction to reset the sequence number counters for a given link.

By associating errors with specific contexts, this architecture provides a fine-grained error recovery strategy. Upon detecting an uncorrectable error, the system 600 is not required to restart the entire large-scale computation. Instead, the poison bit for the specific affected context is set, allowing software to identify and discard the corrupted data and re-execute only the small portion of the computation associated with that context. This can provide for avoiding expensive system-wide pipeline resets and significantly improves the efficiency, throughput, and fault tolerance of the overall system.

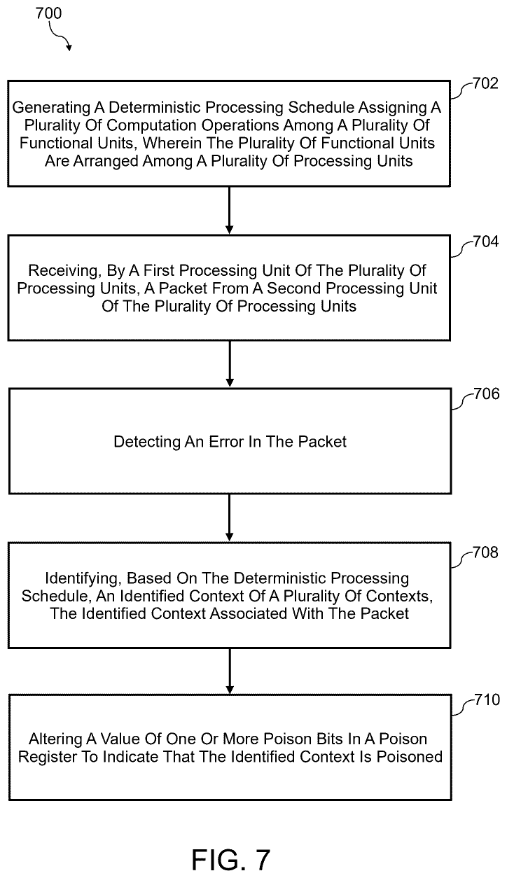

FIG. 7 is a flowchart diagram of an example method 700 for error handling and mitigation in a multiunit system, such as for error correction in chip-to-chip (C2C) communications for a tensor processor, according to example implementations of the present disclosure.

At 702, the method 700 can include generating a deterministic processing schedule assigning a plurality of computation operations among a plurality of functional units. The plurality of functional units may be arranged among a plurality of processing units. For instance, the plurality of processing units and/or functional units may be arranged as part of a rack configuration of language processing units (LPUs) communicating over a plurality of C2C communication links. For example, a rack configuration may consist of multiple server racks, each containing a number of nodes, each node containing a number of language processing units (LPUs), interconnected via high-bandwidth C2C communication links, such as optical links, copper links, or other suitable high-speed interfacing material. The generated deterministic processing schedule defines which of the plurality of functional units will perform which of the plurality of computation operations at specified times. For instance, a schedule might specify that a particular matrix multiplication operation must be performed by functional unit A on LPU 3 during clock cycle 1,050.

At 704, the method includes receiving, by a first processing unit of the plurality of processing units, a packet from a second processing unit of the plurality of processing units. In some embodiments, one or more symbols of the packet are interleaved among the plurality of C2C communication links to mitigate burst errors. As an illustration of interleaving, consecutive data symbols from a single logical stream can be reordered within an output data stream for communication and/or reordered after being received to reconstruct the original data, making the data stream more resilient to a burst of errors on any single link. Examples of interleaving are described herein with respect to FIGS. 3A-3C.

At 706, the method includes detecting an error in the packet. Detecting an error in the packet can involve executing various checks on the packet, such as detecting an invalid checksum of the packet, detecting an invalid sequence counter value in the packet, or identifying that the error is not correctable by a forward error correction (FEC) algorithm. An invalid checksum could be detected, for example, if the receiving unit calculates a CRC value for the packet's data that does not match the CRC value included in the packet's trailer. An invalid sequence counter value might be found if the receiver expects packet number 5 but instead receives packet number 7, indicating that packet 6 was dropped during transmission. An error may be identified as not correctable by a forward error correction (FEC) algorithm when the number of corrupted symbols in a received FEC codeword exceeds the correction capability of the code. For example, the error may be identified as not correctable if sixteen symbol errors occur when a code designed to correct only fifteen (or fewer) errors. In embodiments where the packet is smaller than a codeword length of the FEC algorithm, the packet may be padded with one or more default values at the receiver, such that the default values are not transmitted by the second processing unit but are appended by the first processing unit before decoding. For instance, if an FEC algorithm operates on 544-symbol codewords but a final data packet contains only 200 symbols, the receiving unit, knowing the packet is terminal, appends 344 default values (e.g., zeros) to the packet before performing FEC decoding. The packet may not be padded for transmission to reduce the amount of resources required to transmit the packet. Example padding configurations are described further herein with respect to FIG. 5.

At 708, the method includes identifying, based on the deterministic processing schedule, an identified context of a plurality of contexts, the identified context associated with the packet. The identification process can include accessing timing data of the deterministic processing schedule and identifying the identified context based on the timing data. To perform the identification, the receiving unit can utilize the deterministic processing schedule. For instance, in some implementations, identifying the identified context of the plurality of contexts can include accessing timing data of the deterministic processing schedule, the timing data associating expected packets with contexts and identifying the identified context based on the timing data of the deterministic processing schedule.

For example, if an error is detected at a clock cycle when a packet for context 3 was scheduled to arrive, the system identifies context 3 as the identified context by using the timing data. The plurality of computation operations can define one or more inference tasks associated with one or more users, where the plurality of contexts are respectively associated with the plurality of users. For example, context 1 may be dedicated to a first user's interactive chatbot session, while context 2 handles a batch processing job for a second user. Such inference tasks may comprise evaluating one or more prompts from users by at least one machine-learning model, such as a large language model (LLM). An example inference task involves an LLM generating a response to a query, where evaluating one or more prompts involves the core computation operations being scheduled and monitored for errors.

At 710, the method includes altering a value of one or more poison bits in a poison register to indicate that the identified context is poisoned. After altering the poison bit, the system continues by executing the plurality of computation operations according to the deterministic processing schedule for the other contexts of the plurality of contexts, while repeating at least one computation operation of the plurality of computation operations corresponding to the identified context. Additionally and/or alternatively, in some implementations, the computation for the identified poisoned context can continue uninterrupted until the end of a computational pipeline is reached. This can provide for avoiding potentially computationally expensive branching and/or control flow determination operations. For example, if the error occurred during an attention calculation for the poisoned context, the system proceeds with calculations for all other contexts, while only repeating the specific attention computation operation for the identified context after fetching clean data.

Repeating the computation may involve resetting a program cache, such as a LLM cache or other cache utilized by a machine-learning model (e.g., a key-value (KV) cache), that was utilized in the failed operation. For instance, a generative inference task would involve rewinding the key-value (KV) cache for the poisoned context to ensure the repeated operation does not use the previous, erroneous state, but may proceed without discarding the entire key-value cache, only the portion subsequent to the detected error. The method may further include communicating the value of the poison bit to a third processing unit to propagate the error state information as needed. For example, the system may be communicating the value of the poison bit to a third processing unit that is scheduled to receive the output of the failed computation, thereby preventing the error from propagating further downstream. In cases where a poisoned context is identified during execution of a computational pipeline, the output of a final stage of the computational pipeline may include the poison bit to indicate that the poisoned context should be rewound to a state prior to the occurrence of the error, whereas other, error-free contexts may proceed through a next iteration of the computational pipeline unaffected.

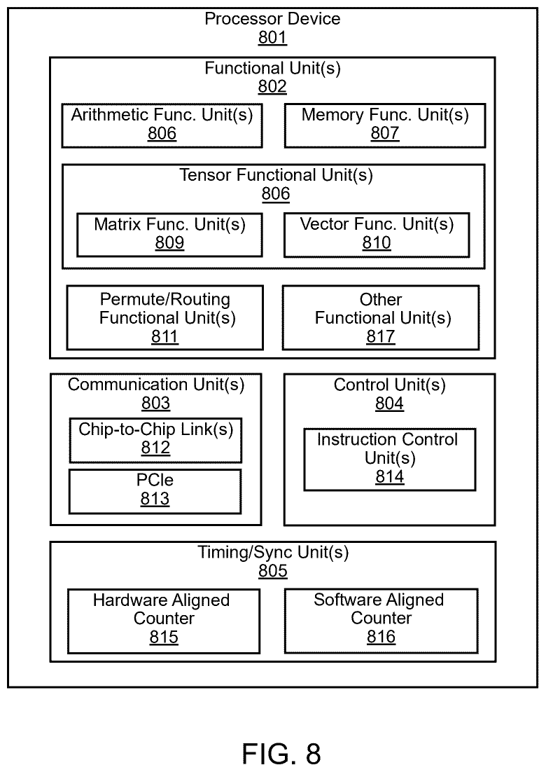

FIG. 8 is a block diagram of an example processor device 801 according to example implementations of aspects of the present disclosure. The processor device 801 can include one or more functional units 802; one or more communication units 803; one or more control units 804 (e.g., instruction control unit(s) 814, etc.); one or more timing or synchronization units 805; or other components. In some instances, functional unit(s) 802 of the processor device 801 can include one or more of: arithmetic functional unit(s) 806; memory functional unit(s) 807; tensor functional unit(s) 808 (e.g., matrix functional unit(s) 809, vector functional unit(s) 810, etc.), permute or routing functional units 811, or other functional units 817. Communication unit(s) 803 can include, for example, one or more of chip-to-chip communication link(s) 812, peripheral component interconnect express 813 components, or other communication unit(s) 803. Timing and synchronization units 805 can include, for example, one or more hardware-aligned counters 815, one or more software-aligned counters 816, or other timing or synchronization component. The processor device 801 can, for example, be or include a “processing unit” as described herein.

A processor device 801 can include various types of processor architectures. In some instances, a processor device 801 can include a single-core or multi-core processor device 801. In some instances, a processor device 801 can include an integrated circuit located on a single die or a processor device 801 distributed over multiple dies connected together (e.g., directly connected such as via face-to-face connection, indirectly connected such as via one or more interposers, etc.). In some instances, a processor device 801 can include one or more of: one or more field-programmable gate arrays (FPGAs); one or more application-specific integrated circuits (ASICs), such as ASICs for machine-learning inference, matrix multiplication, floating-point operations, or the like; one or more graphics processor units (GPUs); one or more tensor processing devices; or other processor type. In some instances, a processor device 801 can include a deterministic processor device or a non-deterministic processor device (e.g., processor device configured to operate according to a deterministic or non-deterministic timing, etc.). In some instances, a processor device 801 can include a processor device having a plurality of dedicated special-purpose functional units, or a processor device having one or more general-purpose functional units (e.g., multi-core processor having a plurality of general-purpose processor cores, etc.). For example, in some instances, a processor device 801 can include a single-core processor device 801 having a plurality of special-purpose functional units 802 having distinct functions, such as functional units 802 having distinct instruction set architectures.

In some instances, a processor device 801 can include a deterministic processor device. A deterministic processor device can include, for example, a processor device configured to perform a plurality of operations according to a predetermined order, such as a predetermined program order defined by a compiler. The order, for instance, can be defined by a deterministic processing schedule including timing data describing a time at which each of a plurality of functional units will perform computational operations. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 802 or other component of a processor device 801 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learning model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 802, communication unit(s) 803, etc.) having an instruction set architecture comprising instructions to control a timing of one or more operations of the one or more components.

In some instances, a deterministic processor device 801 can include a processor device configured to route data between functional units 802 of the processor device 801 according to a predetermined timing, predetermined routing or pathing, or both. For example, in some instances, a deterministic processor device 801 can include a processor device configured to receive compiled instructions comprising data indicative of one or more data transfer operations to be performed according to one or more predetermined routes determined by a compiler, according to one or more predetermined timing values defined by the compiler, or both. In this manner, for instance, a deterministic processor device 801 can enable a compiler to perform compile-time load balancing for a plurality of data paths, and can execute a plurality of runtime data transfers according to the compile-time load balancing.

In some instances, a deterministic processor device 801 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 801 can lack any branch prediction components, and can be configured to execute every operation of a compiled program according to a predetermined program order. As another example, in some instances, one or more memory functional units 807 can lack a cache hierarchy or lack any non-deterministic memory component(s). For example, in some instances, one or more memory functional units 807 can be configured to operate deterministically, such as according to a predetermined timing defined by a compiler. For example, in some instances, one or more memory functional units 807 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 807; or the like. For example, in some instances, the compiler can compile a program or other executable into a set of deterministic operations that can be executed by the functional unit(s) 802 at known times specified by a deterministic schedule.

However, although a deterministic processor device 801 can lack some common sources of non-determinism, in some instances, a deterministic processor device 801 can include or interact with one or more non-deterministic components or devices without deviating from the scope of the present disclosure. As a non-limiting illustrative example, in some instances, a deterministic processor device 801 can include a PCIe 813 component configured to perform external input/output (I/O) operations, which can in some instances include input/output operations having a non-deterministic timing (e.g., I/O operations using a non-deterministic PCIe 813 device; I/O operations receiving input from non-deterministic external device(s); etc.). In some instances, a deterministic processor device 801 can interact with non-deterministic component(s) or device(s) (e.g. components or devices internal or external to the processor, etc.), while maintaining deterministic operation of the remaining components of the processor device 801 by designating one or more predetermined time windows to interact with the non-deterministic component(s) in a deterministic manner. For example, in some instances, a processor device 801 can be configured to check, at each of a plurality of predetermined times, whether one or more inputs (e.g., inference request(s), etc.) has been received via a PCIe device 813; and, if the processor device 801 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 801 can include a processor device configured for single-instruction multiple-data (SIMD) operation. For example, in some instances, a processor device 801 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 802 (e.g., adjacent functional units 802 arranged in a functional region, etc.) to cause each respective functional unit 802 of the plurality of functional units 802 to execute the instruction on one or more distinct operands provided to the respective functional unit 802 (e.g., routed to the respective functional unit 802 according to a predetermined compiler-defined routing, etc.).

In some instances, a processor device 801 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 802, a set of operations defined by the single set of instructions. For example, in some instances, a single-core processor device 801 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 802, the plurality of operations (e.g., SIMD operations wherein each operation is a multiple-data operation, etc.) on the one or more operands.

Functional unit(s) 802 can include, for example, one or more components (e.g., integrated circuit components, etc.) configured to perform operations on one or more operands (e.g., data operands, etc.). In some instances, functional unit(s) 802 can include deterministic functional units 802, such as deterministic functional units configured to perform one or more operations in a predetermined program order, according to a predetermined timing or temporal relationship, or the like. In some instances, a set of functional units 802 can include a plurality of dedicated or special-purpose functional units 802, such as distinct functional units 802 having distinct functions or sets of functions (e.g., limited or specialized function sets, etc.). In some instances, functional unit(s) 802 can include functional units configured to perform multiple operations per instruction for at least some instructions, such as single-instruction multiple-data (SIMD) functional unit(s) 802, and/or functional unit(s) 802 configured to process instruction(s) directed to multiple computing operations (e.g., multiple repetitions of a single type of operation, pipeline of multiple different operations, etc.).

In some instances, a set of dedicated functional unit(s) 802 can include distinct dedicated functional units 802 for each of a plurality of steps in a machine-learning inference pipeline, such as a distinct dedicated functional unit for each component of a category or type of machine-learning model layer (e.g., convolutional layer, attention layer, fully connected layer, etc.). For example, in some instances, a set of dedicated functional units 802 for implementing a fully connected layer of a machine-learning model can include one or more matrix functional units 809 for performing matrix multiplication between a parameter tensor (e.g., weight matrix, etc.) and a tensor (e.g., vector, etc.) of input values to the fully connected layer, and one or more vector functional units 810 for performing an activation function of the fully connected layer. As another example, in some instances, a set of dedicated functional units 802 for implementing a convolutional layer of a machine-learning model can include one or more permute/routing functional units 811 configured to perform one or more data reshaping operations corresponding to one or more convolutions (e.g., two-dimensional convolutions, one-dimensional convolutions, etc.); and one or more other functional units 802 (e.g., matrix functional unit(s) 809, vector functional unit(s) 810, etc.) for performing additional operations associated with a convolutional layer or convolutional neural network (e.g., matrix multiplication, pooling, activation functions, etc.).

In some instances, a plurality of dedicated functional units 802 can include a first functional unit 802 configured to perform a set of operations that is different (e.g., completely disjoint from or partially overlapping, etc.) from a second set of operations associated with a second functional unit 802. In some instances, a plurality of special-purpose or dedicated functional units 802 can have a plurality of distinct instruction set architectures, such as limited or special-purpose instruction set architectures each supporting a limited or special-purpose set of operations. As a non-limiting illustrative example, in some instances, a set of dedicated functional units 802 can include one or more of: a matrix functional unit 809 configured to perform a first set of matrix operations (e.g., matrix multiplication operations, etc.); a vector functional unit 810 configured to perform a set of vector operations different from the matrix operations (e.g., activation function operations such as rectified linear unit (ReLU), sigmoidal, softmax, or other activation function operations; normalization operations; etc.); a permute/routing functional unit 811 configured to perform one or more data routing, data permutation, or data reshaping functions (e.g., tensor permutation or reshaping, etc.) different from the matrix operation(s) and different from the vector operation(s); or other dedicated functional unit(s) 802. Other examples are possible.

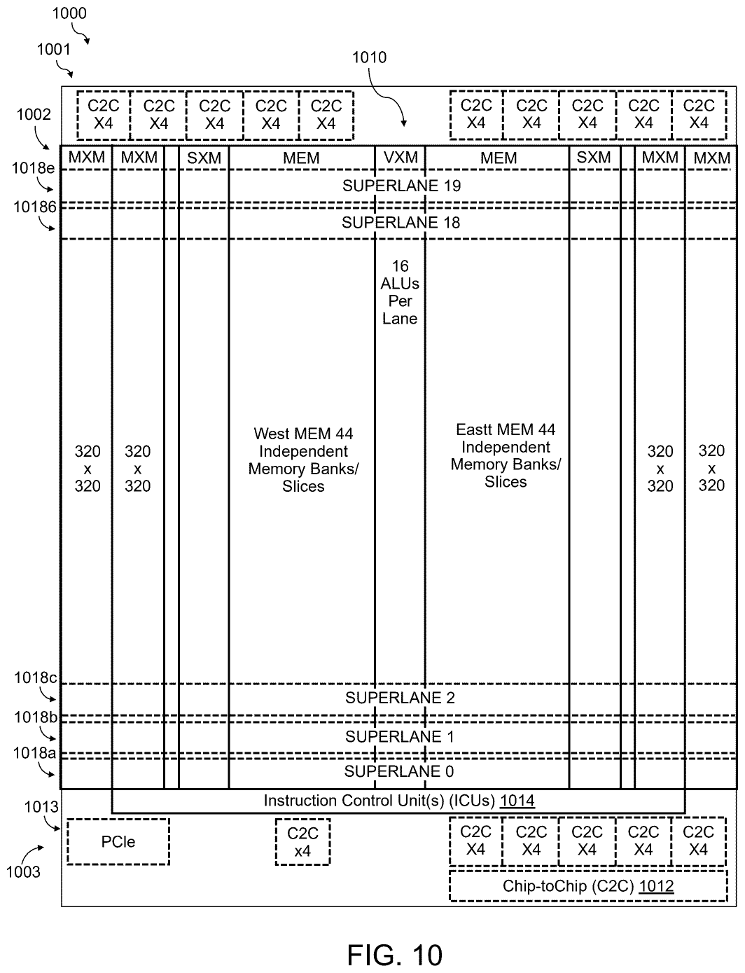

In some instances, functional unit(s) 802 can include functional units organized into functional regions of a processor die, such as compact functional regions configured to facilitate low-latency propagation of instructions or operands within a functional unit 802 or between adjacent functional units 802. As a non-limiting illustrative example, in some instances, one or more functional units 802 can be organized into functional slices along a first axis of a processor die, thereby enabling low-latency propagation of one or more instructions along the axis, low-latency propagation of operand data along a second axis, or the like. Further details of an example processor device comprising functional slices are provided below with respect to FIG. 10.

In some instances, functional unit(s) 802 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learning inference pipelines. For example, in some instances, one or more functional units 802 or functional regions of a processor device 801 for performing a sequentially first operation in a computational pipeline can be geographically close to one or more functional units 802 for performing a sequentially second operation in the computational pipeline. Example computational pipelines can include, for example, inference pipelines associated with common machine-learning model, layer, or head architectures, such as convolutional architectures; attention architectures; fully connected layer architectures; selective structured state space machine architectures; gating architectures (e.g., long short-term memory, etc.); or another machine learning architecture. As described further herein, in some cases, the choice of encoding scheme (e.g., FEC or ECC with interleaving) for a C2C communication link may be at least partially based on the physical length of the communication link.

In some instances, functional unit(s) 802 can include functional units configured to perform multiple operations per instruction for at least some instructions, such as single-instruction multiple-data (SIMD) functional unit(s) 802 or functional units 802 configured to operate without necessarily receiving explicit instructions for each operation. For example, functional unit(s) 802 configured to operate without necessarily receiving explicit instructions for each operation can include one or more of: functional unit(s) 802 configured to receive intermittent instructions and perform multiple operations per instruction (e.g., repeated single operation, pipeline of multiple different operations, etc.); functional unit(s) 802 configured to operate without instructions according to a default operation; or the like. In this manner, for instance, an amount of communication required to provide instructions to the functional units 802 can be reduced, and operation of the processor device 801 can in some instances be simplified compared to some alternative implementations.

For example, in some instances, a SIMD functional unit 802 can include a tensor functional unit 808 configured to execute an instruction on a plurality of numerical values, such as a vector or matrix of numerical values. For example, in some instances, a tensor functional unit 808 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples described below with respect to FIG. 10). In some instances, a tensor functional unit 808 can be configured to process some or all of a plurality of values simultaneously, or to execute a single-instruction multiple-data instruction according to a staggered timing.

As another example, in some instances, a functional unit 802 configured to operate based on intermittent instructions can include a functional unit 802 configured to repeat one or more operations, such as a functional unit 802 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 802 can include a functional unit 802 configured to receive and execute one or more repetition instructions (e.g., having an instruction set architecture comprising one or more repetition instructions, etc.). A repetition instruction can include, for example, an instruction to cause the functional unit 802 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 802 location, memory location, data path location, etc.) associated with a repeated operation, or other offset parameter.

As another example, in some instances, a functional unit 802 can include a functional unit 802 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 802 can include a pipelined hardware architecture (e.g., systolic array pipelined hardware, deterministic streaming hardware such as hardware having one or more properties described with respect to FIG. 10, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 802 can include a geographically compact architecture, wherein a plurality of components for performing a multi-operation instruction can be adjacent or otherwise close together on a processor die.

An arithmetic functional unit 806 can include, for example, one or more functional units 802 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 806 can be a tensor functional unit 808 or component thereof, or have one or more properties described below with respect to tensor functional unit(s) 808.

A memory functional unit 807 can include, for example, one or more functional units 802 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learning model weights, compiled computer-executable instructions, etc.), or other storage. In some instances, a memory functional unit 807 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

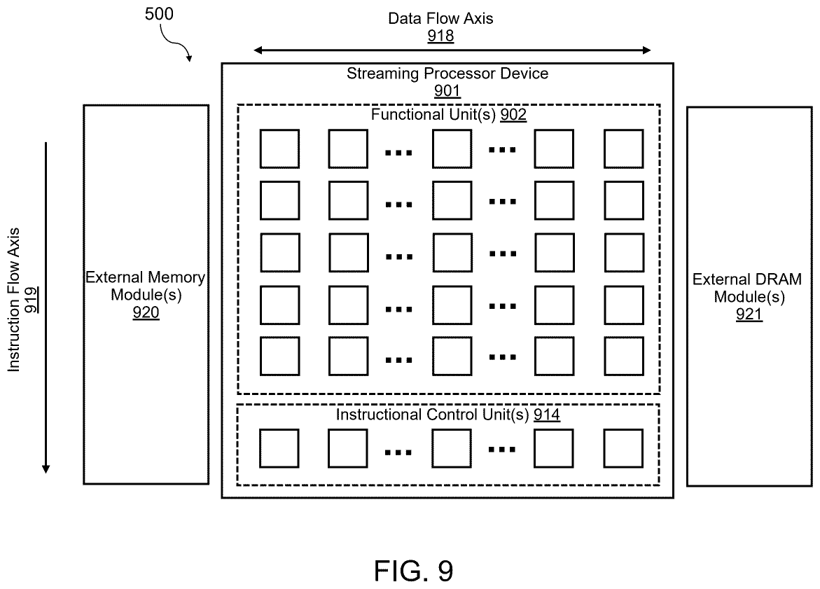

In some instances, one or more memory functional units 807 can be configured to share a global address space accessible to a plurality of functional units 802. For example, in some instances, a global address space can include all memory locations available to the processor device 801 (e.g., including any external memory modules, etc.), such that any functional unit 802 of the processor device 801 can obtain (e.g., receive at a predetermined time defined by the compiler, such as without requiring the functional unit 802 to output any request for the data obtained). In some instances, a set of memory functional unit(s) 807 can include, or a processor device 801 can have access to, one or more internal (e.g., on-chip) memory functional units 807; one or more external (e.g., off-chip, near-compute, etc.) memory units; or both. Further details of some example near-compute external memory units are provided below with respect to FIG. 9, while details of some example on-chip memory units are provided below with respect to FIG. 10.

A tensor processing unit 808 can include, for example, a functional unit 802 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 808 can include a matrix functional unit 809; a vector functional unit 810; or another functional unit.

A matrix processing unit 809 can include, for example, a functional unit 802 configured to perform one or more operations on a matrix (e.g., two-dimensional matrix, flattened matrix, etc.) of operands (e.g., numerical values such as floating-point values, etc.). In some instances, a matrix processing unit 809 can include a functional unit 802 configured to perform matrix multiplication or other matrix operations.

A vector processing unit 810 can include, for example, a functional unit 802 configured to perform one or more operations on a vector (e.g., one-dimensional vector, flattened tensor, etc.) of operands (e.g., floating-point numerical values, etc.). In some instances, a vector processing unit 810 can include a functional unit 802 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 811 can include, for example, a functional unit 802 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 807; a tensor, matrix, or vector functional unit 808, 809, 810; or a permute/routing functional unit 811 can be or include a deterministic functional unit 802 configured to execute instruction(s) at a predetermined time defined by a compiler; a single-instruction multiple-operation functional unit 802 configured to perform a plurality of operations based on one instruction; or have any other property described herein with respect to functional unit(s) 802. Further details of some example functional units 807, 809, 810, 811 are provided below with respect to FIG. 10.

Communication units 803 can include various components for performing communication operations (e.g., input, output, etc.) between the processor device 801 and other devices (e.g., processor devices, computing devices, external memory devices, etc.) or components, or within the processor device 801. In some instances, communication units 803 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 801 can include a plurality of deterministic chip-to-chip communication links 812 configured to communicate with other deterministic processor devices 801 (e.g., using deterministic communication operations having a predetermined timing, communication path, or other property), along with one or more PCIe components 813 configured to interact with one or more non-deterministic components. In some instances, communication units 803 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 801 such as routers, repeaters, switches, panels, or the like); or other components configured to facilitate one or more communication operations.

Chip-to-chip communication units 812 can include, for example, any device or component for communicating with another processor device (e.g., processor device 801, etc.), such as one or more serializer-deserializer units, one or more communication channels (e.g., signal lines, etc.), one or more connection components (e.g., ports, pins, connection pads, etc.), or the like. In some instances, a processor 801 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 801. In some instances, chip-to-chip communication units 812 can include units configured to communicate with processor devices that are geographically close to or far away from the processor device 801 (e.g., in a same or different compute node as the processor device 801; in a same or different rack; etc.). In some instances, chip-to-chip communication units 812 can include connections to a plurality of distinct chips, a plurality of connections to a single chip, or both. In some instances, chip-to-chip communication units 812 can include chip-to-chip communication units 812 associated with one or more bidirectional communication channels, one or more unidirectional communication channels, or both. In some instances, chip-to-chip communication units 812 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 805 can be used to provide synchronization for one or more processor devices 801 to facilitate deterministic-timing communication between chips.

A peripheral component interconnect express (PCIe) component 813 can include, for example, a communication device configured to facilitate communication between a processor device 801 and one or more other devices (e.g., computing devices; processor devices; data storage devices; auxiliary devices; etc.). In some instances, a PCIe unit 813 can include a communication system conforming to one or more PCIe communication standards (e.g., PCIe 6.0, PCIe 7.0, etc.). Although FIG. 8 depicts a PCIe unit 813, other communication units or communication standards can be used without deviating from the scope of the present disclosure. In some instances, a processor device 801 can include a deterministic processor device 801 configured to communicate non-deterministically via the PCIe unit 813 while maintaining determinism in the functional unit(s) 802 of the processor device 801 (e.g., according to methods described above).

In some instances, control unit(s) 804 can include one or more devices for controlling one or more operations of the functional unit(s) 802, such as device(s) configured to supply one or more control signals (e.g., assembly code or machine code instructions; switching signals, multiplexer selection signals, etc.) to one or more functional unit(s) 802.

In some instances, control unit(s) 804 can include one or more instruction control unit(s) 814 configured to supply computer-executable instruction(s) to one or more functional units. In some instances, an instruction control unit 814 can include a deterministic instruction control unit 814 configured to supply instruction(s) to the functional unit(s) 802 according to a predefined program order determined by the compiler; supply instruction(s) at one or more predefined times (e.g., clock cycles, etc.); or the like. In some instances, an instruction control unit 814 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 802 at a second time (e.g., second time predetermined by the compiler, etc.)

In some instances, instruction(s) provided to a functional unit 802 by an instruction control unit 814 can be the same as or different from a corresponding instruction received by the instruction control unit 814. For example, in some instances, an instruction control unit 814 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 807, a compiled instruction; and providing, based on the compiled instruction, a plurality of control signals to one or more (e.g., a plurality of) functional units 802 over one or more (e.g., a plurality of) clock cycles. In some instances, a memory-efficient stored instruction can include a multi-operation instruction associated with a plurality of related operations (e.g., operations of a machine-learning model layer such as matrix multiplication, activation functions, convolution, attention, or the like), and the translated control signals can include a plurality of control signals (e.g., lower-level instructions, etc.) for executing the multi-operation instruction. In some instances, an instruction control unit 814 can include hardware configured to receive an instruction comprising one or more timing parameters (e.g., delay amounts, etc.) or repetition parameters, and output control signal(s) to the functional unit(s) 802 to cause the functional units to perform operations according to the timing or repetition parameters (e.g., at a predetermined clock cycle defined by a compiler, etc.). In some instances, the instruction control unit 814 can control a timing or a number of repetitions of the functional unit(s) 802 by sending control signals comprising timing or repetition data, or by sending raw control signals at a specific time or plurality of times configured to cause the functional unit(s) 802 to perform operations according to one or more timing or repetition parameters.

In some instances, timing and synchronization units 805 can include various components configured to perform synchronization operations, such as operations to track or communicate time data (e.g., current clock cycle data, etc.) to one or more functional units 802 or other components of a processor device 801. In some instances, timing and synchronization units 805 can include one or more of: one or more hardware-aligned counters 815, one or more software-aligned counters 816, or other timing or synchronization component.

Hardware aligned counters 815 may be used to establish a time base for electronic circuitry in each system, such as a clock, for example. Additionally, each system may include software aligned counters 816. Software aligned counters 816 may be synchronized, for example, based on one or more computer-executable instructions (e.g., compiled instructions determined by a compiler, etc.). Hardware aligned counters 815 and software aligned counters 816 may be implemented as digital counter circuits, for example, on each integrated circuit (e.g., each processor device 801 or each die thereof, etc.). For instance, hardware aligned counters 815 may be free-running digital counters (e.g., 8-bit counters) on a processor device 801 that are synchronized periodically. Similarly, software aligned counters 816 may be digital counters (e.g., 8-bit counters) that can be synchronized based on timing markers triggered by one or more compiled programs.

In some instances, timing and synchronization units 805 can include one or more components 805 for internal synchronization of a plurality of components (e.g., functional units 802, etc.) of a processor device 801; one or more components 805 for external synchronization between a first processor device 801 and one or more other devices (e.g., a plurality of second processor devices 801, etc.); or both.

In some instances, synchronizing a first device (e.g., first processor device 801 or another device) with a second device (e.g., second processor device 801 or another device, etc.) can include, for example, synchronizing one or more hardware aligned counters 815 of the first processor device 801 with one or more hardware aligned counters of the second device. Synchronizing the hardware aligned counters 815 may occur periodically during the operation of each system and may occur at a higher frequency than synchronizing software counters 816, for example. Synchronizing hardware counters may include the first device sending a timing reference (e.g., timing bits representing a time stamp) to the second device over a communication channel (e.g., via chip-to-chip communication units 812, etc.). In some instances, a first system may send an 8-bit time stamp, for example. In such a scenario, a hardware counter 815 and software counter 816 of the first device may be maintained in sync locally. However, as the hardware counter 815 on a second device is synchronized to the hardware counter 815 on a second device, the software counter 816 on the second device may drift.

In some instances, software aligned counters 816 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 815 are synchronized. In some instances, these timing markers may be used to synchronize software counters 816 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 816 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 815 of a pair of devices can include sending, by a first device at a first time to, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 815 to a value of (t₀+Δt) such that the hardware aligned counters 815 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 816 can be synchronized in a manner similar to synchronization of hardware aligned counters 815. For example, in some instances, a software aligned counter 816 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 801 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 9 is a block diagram of an example system 900. The system 900 includes a processor device 901 comprising a plurality of functional units 902 and a plurality of instruction control units 914. In some instances, processor device 901 can be configured to transmit (e.g., stream, propagate, etc.) operand data along a data flow axis 918 and transmit instruction data along an instruction flow axis 919. In some instances, the processor device 901 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 902 for executing the instruction at a predetermined time (e.g., clock cycle) selected by the compiler. In some instances, a processor device 901 can be configured to access one or more external memory modules 920 (e.g., near-compute external memory modules 920, etc.), such as one or more external dynamic random access memory (DRAM) modules 921.

In some instances, a processor device 901 can be, comprise, be comprised by, or otherwise share one or more properties with a processor device 801. For example, in some instances, a processor device 901 can have any property described herein with respect to a processor device 801, and vice versa.

In some instances, a functional unit 902 can be, comprise, be comprised by, or otherwise share one or more properties with a functional unit 802. For example, in some instances, a functional unit 902 can have any property described herein with respect to a functional unit 802, and vice versa.

In some instances, a data flow axis 918 can include a direction, axis, or path along which operand data can flow. For example, in some instances, one or more functional units 902 can be configured to receive one or more input operands along the data flow axis; process the input operands to generate one or more output values; and transmit the output values along the data flow axis 918 to another functional unit 902, which can use the output values as input operands, and so on. In some instances, functional units 902 configured to perform related operations (e.g., pairs of operations associated with some machine-learning inference pipelines, etc.) can be located close together along the data flow axis 918; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learning inference operations, etc.). For example, in some instances, a series of related operations for machine-learning inference can include one or more of: matrix multiplication (e.g., multiplying machine-learning model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 918 can include a physical axis or a logical axis, such as an operand flow path that may include or not include a straight-line operand flow path. In some instances, all or part of a data flow axis 918 can be orthogonal (e.g., logically orthogonal, physically orthogonal, etc.) to an instruction flow axis 919.

In some instances, an instruction flow axis 919 can include a direction, axis, or path along which instruction data can flow. For example, in some instances, an instruction control unit 914 can be configured to provide, to one or more first functional units 902, an instruction; and the first functional unit(s) 902 can be configured to execute the instruction and/or pass the instruction along to neighboring functional units 902 along the instruction flow axis 919. In some instances, a plurality of neighboring functional units along the instruction flow axis 919 can include a plurality of functional units 902 performing similar (e.g., same) functions, such as a plurality of memory functional units 907 or the like. In some instances, a plurality of neighboring functional units along the instruction flow axis 919 can include a plurality of functional units 902 configured to execute the same instruction received from an instruction control unit 914 and propagated along the instruction flow axis. In some instances, an instruction flow axis 919 can include a physical axis or a logical axis, such as an operand flow path that may include or not include a straight-line operand flow path. In some instances, all or part of an instruction flow axis 919 can be orthogonal (e.g., logically orthogonal, physically orthogonal, etc.) to a data flow axis 918.

In some instances, a processor device 901 can include a deterministic processor device 901 comprising a plurality of deterministic functional units 902 configured to perform one or more operations at a predetermined time defined by a compiler at compile time. In some instances, a compiler can control a timing of one or more instruction and data flows to cause one or more instructions traversing the instruction flow axis 919 to intersect one or more operands traversing the data flow axis 918 at a functional unit 902 scheduled to execute the instruction(s) on the operand(s) at a predefined time instant selected by the compiler.

In some instances, a processor device 901 can include a plurality of functional tiles 902, which can include functional units 902 arranged in a tiled arrangement on a processor die. The functional tiles 902 can perform various functions such as vector-matrix multiplication, switching of data along different circuit pathways, and local data storage and retrieval. In some instances, functional tiles 902 can share a common system clock. In some instances, functional tiles 902 can include one or more sets of interconnected functional tiles 902 processing the same data, such as interconnected functional tiles 902 that are adjacent along a data flow axis 918; at a same location along an instruction flow axis 919; or the like. In some instances, a plurality of interconnected functional tiles 902 processing the same data can be referred to herein as a “lane” or “Superlane.” For example, in some instances, each functional tile 902 in a Superlane can be subdivided into 16 sub-tiles, and a set of subtiles processing the same data can be referred to herein as ‘lanes’. A set of data that is processed by one Superlane is referred to herein as a ‘stream’. In some instances, each lane in a tile of a Superlane can be configured to process one byte (e.g., one byte per clock cycle, one byte at a time, etc.).

In some instances, an instruction control unit 914 can be, comprise, be comprised by, or otherwise share one or more properties with an instruction control unit 814. For example, in some instances, an instruction control unit 914 can have any property described herein with respect to an instruction control unit 814, and vice versa.

In some instances, data between two adjacent functional tiles 902 can flow bidirectionally, or can primarily (e.g., most or all of the time) move in one direction along a lane or Superlane. In some instances, a first Superlane can have a direction of flow along the data flow axis 918 that is the same as or different from a direction of flow of a second Superlane. In some instances, operand data can be transferred along the data flow axis 919 at every clock cycle of a processor device 901. In some instances, when processing of operand data is complete in one Superlane, the data can be either returned to a host computer comprising the processor device 901 or transferred (e.g., by permute/routing functional units 811, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 901 contains N (e.g., 20, etc.) adjacent Superlanes, then an instruction can be passed to N adjacent functional tiles 902 (e.g., over the course of N clock cycles, etc.), and each instruction can execute on all 16*N (e.g., 320) lanes across the N Superlanes. In some instances, a processor device 901 architecture can include an architecture that lacks register files, and a compiler can schedule the streaming data to be available to the functional tile 902 at a predetermined designated time to execute a designated instruction.

An external memory module 920 can include, for example, a memory device that is external to the processor device 901, such as a memory device on a separate die from the processor device 901 or the like. In some instances, an external memory module 920 can have one or more properties that are the same as or different from one or more properties of a memory functional unit 807. For example, in some instances, an external memory module 920 can include any memory type or device type described herein with respect to a memory functional unit 807. As another example, in some instances, an external memory module 920 can use a first type of memory that is different from a second type of memory used in an on-chip memory functional unit 807. For example, in some instances, a memory functional unit 807 can include a low-latency memory type such as SRAM, and an external memory module 920 can use one or more lower-cost or higher-storage-capacity memory types, such as dynamic random access memory (DRAM). Other memory types are possible without deviating from the scope of the present disclosure (e.g., SRAM or other non-volatile memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory module can have any property described herein with respect to an external dynamic random access memory (DRAM) module 921, and vice versa.

In some instances, an external dynamic random access memory (DRAM) module 921 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory module 920, 921 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory module 920, 921 can include a plurality of memory banks, wherein each bank has a plurality of rows for storing data. Each memory bank can be addressable by a processor device 901 for writing data to selected rows in selected banks and for reading data from selected rows in selected banks, wherein data can be read a predetermined time-period before the data is required to arrive at one or more compute element(s) of the processor 901 and data can be written to a memory at a first predetermined time-period that does not coincide with a memory refresh scheduled to occur at a second predetermined time.

In some instances, an external memory module 920, 921 can include various features to enable high-bandwidth memory access, high levels of memory concurrency, or the like. For example, in some instances, an external memory module 920, 921 can provide deterministic memory access functions (e.g., deterministic-latency operations, etc.) to enable a compiler to control a timing of a plurality of data read, write, or refresh operations; control a level of memory concurrency for accessing a plurality of operands or other data from an external memory module 920, 921; or other memory control functions. As another example, in some instances, an external memory module 920, 921 can include a plurality of concurrently accessible memory banks (e.g., memory banks configured to be active simultaneously, etc.), thereby increasing a memory bandwidth of the external memory module 920, 921. In some instances, an external memory module 920, 921 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory module 920, 921 operations.

In some instances, an external memory module 920, 921 can include a deterministic memory module having low-random-transaction-rate (low-RTR) memory (e.g., DRAM banks, etc.), and a processor device 901 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory module 920, 921 can have one or more features to reduce a power consumption of the external memory module 920, 921 compared to some alternative implementations. For example, in some instances, an external memory module 920, 921 can be placed in close proximity to a processor device 901 to reduce (e.g., minimize or nearly minimize) an amount of power consumed in reading or writing data to the memory module 920, 921 (e.g., due to lower capacitive loading of short signal traces, etc.). In some instances, placing an external memory module 920, 921 in close proximity to a processor device 901 can include connecting the module 920, 921 to the processor device 901 in various manners, such as by face-to-face coupling (e.g., using wafer stacking technology, etc.) or another connection technique (e.g., passive interposer, active interposer, etc.). In some instances, a low-power external memory module 920, 921 can include a memory component (e.g., DRAM component) having sense amps attached directly to row input/output (e.g., without a logic layer or without data buffer(s), etc.).

In some instances, an external memory module 920, 921 can include one or more logic dies and a plurality of memory banks, such as a logic die coupled to a plurality of DRAM banks by through-silicon via and to a processor device 901 in a face to face configuration, etc. In some instances, a logic die can include row buffers for interfacing the processor device 901 to one or more memory components. The memory component(s) can also have an array core and a row decoder. During a read operation, the row decoder can select a row of array core and the entire row from the selected row can be transferred from the memory component to row buffers on the logic die. In some instances, a memory component or an external memory module 920, 921 can lack column decoders and can read or write an entire row during each R/W cycle. In some instances, a memory plane can include 3D NOR memory.

In some instances, an external memory module 920, 921 can provide a global address space available to a plurality of functional units 902. For example, in some instances, global memory access can be facilitated by one or more permute/routing functional unit(s) 811 of a processor device 901 to allow any processor 901 component at any location on a die to access data residing in any memory bank element of an external memory module 920, 921 or memory functional unit 807.

For example, in some instances, a streaming processor device 901 can provide operand data movement along a data flow axis 918 automatically (e.g., at every clock cycle, etc.), while one or more permute/routing functional unit(s) 811 can provide (e.g., responsive to one or more compiled instructions, etc.) operand data movement along an instruction flow axis 919. Further details of an example permute/routing functional unit 811 providing operand data movement along an instruction flow axis 919 are provided below with respect to FIG. 10.

In some instances, a processor device 901 can have sufficient permute/routing functional unit(s) 811 or data flow operations (e.g., routed data flow, automatic or unrouted data flow, etc.) to enable any retrieved data to be mapped to any functional unit 802 or port thereof. In some instances, permute/routing functional unit(s) 811 can provide additional operations in association with memory retrieval, such as data reshaping, padding (e.g., padding a size of a tensor by adding a plurality of zeros, etc.), duplication, or other data routing operations.

In some instances, a processor device 901 and external memory module 920, 921 can operate deterministically (e.g., with deterministic timing, order of operations, etc.), and can have various features to take advantage of such determinism. For example, in some instances, a deterministic processor device 901 can initiate one or more data retrieval operations a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to enable lower-RTR memory device(s) to perform similarly to a high-RTR memory of some alternative implementations. As another example, in some instances, given a processor device 901 that is deterministic, an external memory module 920 can perform non-destructive row reads, as each row can write new data if aligned with a closing row. This can provide for, for example, improved performance, reduced power usage, or both. In some instances, a deterministic processor device 901 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 901 can also treat the external memory module(s) 920, 921 as a circular read/write access medium having an opportunity to read and write every row location. For example, a row address line of an off-chip deterministic near-compute memory unit 920, 921 can be coupled to a clock. The row address line can be configured to receive a row address from the processor device 901 and increment every clock cycle in accordance with the circular medium access until the row address loops back without explicit addressing. This pattern can provide for even further power reduction and performance improvement while implicitly incorporating refresh support.

In some instances, a processor device 901 can use one or more memory functional unit(s) 807 (e.g., SRAM units, etc.) or another buffer device (e.g., external SRAM units interposed between a processor device 901 and external DRAM module 921, etc.) as a buffer to temporarily store data retrieved from the external memory module(s) 920, 921, or the processor device 901 can be configured to provide retrieved data directly to one or more functional unit(s) 902 for processing or routing (e.g., traversal of a data flow axis 918, etc.).

FIG. 10 is a block diagram of an example system 1000 including a tensor streaming processor device 1001 according to example implementations of aspects of the present disclosure. The tensor streaming processor (TSP) device 1001 can include a plurality of functional slices 1002, along with a plurality of data paths 1018a, b, c, d, e between the functional slices 1002. In some instances, the functional slices 1002 can include one or more vector functional slices 1010, one or more memory functional slices 1007, one or more permute/routing functional slices 1011, and one or more matrix functional slices 1009. In some instances, a tensor streaming processor 1001 can further include a plurality of communication units 803 (e.g., PCIe unit(s) 1013, chip-to-chip communication unit(s) 1012, etc.); a plurality of instruction control unit(s) 1014; or other component(s).

In some instances, one or more of a processing device 1001, functional unit 1002, communication unit 1003, memory functional unit 1007, matrix functional unit 1009, vector functional unit 1010, permute/routing functional unit 1011, chip-to-chip link 1012, PCIe 1013, or instruction control unit 1014 can be, comprise, be comprised by, or otherwise share one or more properties with a component having a similar (e.g., same, etc.) name or part number described herein with respect to another Figure, such as FIG. 8 or 9. For example, in some instances, a processing device 1001 can have any property described herein with respect to a processing device 801 or processing device 901, and vice versa; a functional slice 1002 can have any property described herein with respect to a functional unit 802 or functional unit 902, and vice versa; and so on.

In some instances, a processor device 1001 can include one or more functional regions or sets of functional units 1002 with the same functionality executing the same instructions, such as functional tiles 1002 located in similar positions in different Superlanes (e.g., at a same point along a data flow axis 918, etc.). In some instances, such a functional region or set of functional units 1002 with the same functionality executing the same instructions can be referred to herein as a functional ‘slice.’ In some instances, a processor device 1001 can include one or more sets of directly connected slices of the same functional modules, encompassing all the Superlanes, referred to herein as a ‘partition’.

In some instances, a TSP 1001 can include a plurality of slices, wherein each slice in a TSP can perform any of a variety of functions under the control of instructions transferred from buffers in the Instruction Control Unit 1014. For example, in some instances, functional slices 1002 can include memory functional slices 1007 for memory storage and retrieval for data in a Superlane (MEM); functional slices 1002 (e.g., matrix or vector functional slices 1009, 1010, etc.) for integer (INT) arithmetic or floating point (FPU) arithmetic; or permute/routing functional slices 1011 for transferring data between Superlanes (NET or SXM). In some embodiments, each of the functional slices 1002 can operate independently, and operations of different functional slices 1002 can be coordinated using barrier-like synchronization instructions.

For example, the memory functional slices 1007 can perform Read and Write operations but not Add or Mul, which can in some instances be performed only in matrix functional slices 1009 and vector functional slices 1010. In some instances, all of a plurality of tiles in a functional slice 1002 can execute the same set of instructions, so it is possible to locate all of the common instruction decode and dispatch logic into the ICU 1014, and partition the normal instruction execution pipeline into two sets of instructions: (i) instruction fetch, decode, and parceling and (ii) operand read, execute, and writeback. Functional slices 1002 or components thereof can operate without having to receive explicit instructions, or only receiving intermittent or limited instructions, from the ICU when the tiles are dedicated to a specific function, potentially simplifying operation of the processor.

In some instances, a functional slice 1002 can include a plurality of functional tiles 902 (e.g., tiles organized along an instruction flow axis 919, etc.). In some instances, functional tiles in the same functional slice 1002 (but not necessarily the same Superlane) can execute instructions in a “staggered” fashion where instructions are issued tile-by-tile within the slice over a period of N cycles. For example, the ICU 1014 for a given slice may, during a first clock cycle, issue an instruction to a first tile of the slice (e.g., the tile directly connected to the ICU of the slice), which is passed to subsequent tiles of the slice along an instruction flow axis 919 over subsequent cycles.

In some instances, a processor device 1001 can include a first and second matrix functional slice 1009 or first and second set of matrix functional slices 1009; a first and second permute/routing slice 1011 or first and second set of permute/routing slices 1011; a first and second memory slice or first and second set of memory slices 1007; and a first vector functional slice 1010. For example, in some instances, each Superlane can include a first set and second set of matrix multiplication tiles (MXM1 and MXM2), a first and second set of data path switching tiles (SXM1 and SXM2), a first and second set of memory tiles (MEM1 and MEM2), and a first set of vector calculation tiles (VXM1), wherein just one tile in MXM1 transfers data with one tile in SXM1, wherein just one tile in SXM1 transfers said data with just one tile in MEM1, wherein just one tile in MEM1 transfers said data with just one tile in VXM1, wherein just one tile in VXM1 transfers said data with just one tile in MEM2, wherein just one tile in MEM2 transfers said data with just one tile in SXM2, and wherein just one tile in SXM2 transfers said data with just one tile in MXM2.

In the above example, data transfers are entirely in one direction, for example MXM1 to SXM1 to MEM1 to VXM1 to MEM2 to SXM2 to MXM2. However, in other examples, data transfers can occur in multiple (e.g., two, etc.) directions, for example, one set of data transfers from VXM1 to MEM1 to SXM1 to MXM1, and another set of data transfers from VXM1 to MEM2 to SXM2 to MXM2.

In some instances, each Superlane, and in some instances the entire TSP 1001, can execute a single set of instructions, such that the TSP 1001 may be considered as a single processor core. However, in some instances, the TSP 1001 Superlanes can be partitioned into two sets of functional modules. For example, in a split architecture with only one central vector functional slice 1010, a central vector multiplication tile that contains 16 ALUs can allocate the ALUs to either set. In other instances, additional vector functional slices 1010 may be allocated to a set. The additional vector functional slices 1010 may be physically or logically located, for example, next to one of the matrix functional slices 1009.

For at least one embodiment, FIG. 10 can depict the silicon layout of a TSP 1001 with multiple Superlanes, as well as processor chip to processor chip (C2C) interface modules 1012 and the ICUs 1014. In this example embodiment, there are 20 Superlanes forming the majority of the floorplan of the laid-out silicon circuitry. Surrounding the Superlane partitions is circuitry for the ICUs, modules for processor-to-processor communication, and modules for host-to-processor communication. In one embodiment, the host-to-processor modules comprises a PCIe (Peripheral Component Interconnect Express) circuit 1013. In some instances, a host-to-processor communication module can bidirectionally transfer data from the host computer through a permute/routing functional slice 1011 to and from a memory functional slice 1007. In some embodiments, a processor-to-processor communication C2C module 1012 directly transfers data to a permute/routing functional slice 1011.

In some instances, a TSP 1001 can include a large on-chip Static Random Access Memory (SRAM), which can in some instances reduce or eliminate a need for external memory. For this reason, a TSP 1001 may not need to include DRAM controllers and interfaces. However, a processor device 801, 901, 1001 can include a processor device configured to interact with external memory (e.g., external DRAM, etc.) without deviating from the scope of the present disclosure. Some example TSP 1001 chips can include an x16 PCI Express (PCIe) Gen4 interface to connect to a host processor (e.g., central processing unit of a host computing device, etc.). In some instances, compilers that execute on the host computer or another device can download the machine learning algorithm instructions and data to the TSP 1001, typically from the host computer through the PCIe interface 1013 through permute/routing functional units 811 (e.g., tiles, etc.) adjacent to the PCIe interface 1013 into the memory functional slices 1007 (e.g., MEM partitions comprising one or more memory functional slices 1007, etc.). The TSP 1001 can then autonomously execute the model by transferring the instructions and data in the MEM partitions into one or more functional slices 1002. After processing, in some instances, results can be transferred from one or more functional slices 1002 (e.g., vector functional slice(s) 1010, etc.) back to the host computer (e.g., via one or more permute/routing slices 1011 and via one or more PCIe devices 1013).

### Streams

Machine learning algorithms can in some instances operate on vectors with scalar coefficients of a specified data type (e.g., INT8, FP16, etc.). In some instances, Superlanes of a TSP 1001 can operate on data representing vectors, sometimes organized into rank-2 tensors. In some instances, a TSP 1001 can operate on higher-rank tensors by using a compiler to transform higher rank tensors into rank-2 tensors. In some instances, a TSP 1001 can implement a programming model that is a producer-consumer model where each slice in a partition acts as a consumer and a producer of one or more streams.

In some instances, a TSP 1001 architecture can support a plurality of streams (e.g., 32 streams, etc.) in each set of tiles in two directions. In some instances, a number of streams can be dependent on the availability of wiring of the inputs and outputs for the stream registers. In some instances, each stream can automatically progress in a designated direction (e.g., designated direction along a data flow axis 918 or data path 1018, etc.) on every cycle (e.g., moving 32 bytes each cycle via 32 streams, etc.). In some instances, inter-lane data movement (e.g., data operand movement in a direction other than the data flow axis 918, etc.) within a vector can be performed using a permute/routing functional slice 1011.

When a set of data representing a vector is read from main memory, it can be given a stream identifier (0 . . . 31) and direction of flow in a Superlane. Once a vector is read into one or more stream registers in a lane, it can become a stream and flow towards a functional slice 1002 that is scheduled to process the vector, and the functional slice 1002 can process the vector to produce a result stream. As data in a stream flows through a slice, each functional module can intercept the data and perform a calculation (if the module is calculational), or move data between lanes (e.g., in permute/routing functional slice(s) 1011).

The stream registers can be used to transfer operands and results between slices. An example software pattern can include reading operand data from one or more memory functional slices 1007 that is then subsequently consumed and operated on by a downstream arithmetic slice (e.g., matrix functional slice 1009, vector functional slice 1010, etc.). The results of the operation can then be transferred to another stream such that they can be written back to memory. For example, a Z=X+Y operation might be performed by executing four instructions: Read S1,X and Read S2,Y are executed on two memory functional slices 1007 and directed toward a vector functional slice 1010 to perform the Add S1,S2,S3. Then the result can be stored back to a memory functional slice 1007 via a Write S3,Z.

An instruction can operate on data from different streams. For example, ADD S1, S2, S3 adds each value in stream 1 to the corresponding value in stream 2 and stores the results in stream 3.

In some instances, a functional slice 1002 can include a functional unit 802 configured to perform a given operation (e.g., operation associated with a single instruction received from an instruction control unit 1014, etc.) for a plurality of repetitions on operands streamed over a plurality of clock cycles. For example, in some instances, a functional slice 1002 or component thereof (e.g., functional tile, etc.) can be configured to receive an instruction comprising repetition data indicative of a number of times to repeat a given operation; a number of clock cycles to delay between repetitions of the given operation; or other repetition data. Based on the instruction, the functional slice 1002 can perform, at each of a plurality of clock cycles, the given operation on one or more operands arriving in one or more streams (e.g., Superlanes, etc.) at each of the plurality of clock cycles.

A lane structure configured to hold one byte per lane can be well suited for INT8 data, but larger operands (INT16, INT32, FP16, or FP32) can also be formed by combining streams. This approach can provide for a compiler to operate, for example, on 320-element vectors for all data types. Wider data types can be assigned to adjacent streams along aligned boundaries. For increased reliability, a Superlane can apply a 9-bit error-correction code (ECC) across all 16 lanes, correcting nearly all errors. A TSP 1001 can log these errors and report them to a host computer. In one embodiment, the ECC protocol is SECDED (single-error correction with double error detection). Before a functional slice operates on a stream of data, it can check the ECC bits to ensure data integrity before operating on the data.

In some instances, each element of a stream can be 1-byte, with larger data types (e.g. INT16, INT32, and FP32) constructed from several streams (2, 4, and 4 respectively). Multi-byte data types can be handled such that they are always stream-aligned based on the size of the data type. For instance, INT16 can be aligned on a stream pair, bi-stream, and INT32 can be aligned on a quad-stream (e.g., one set of four adjacent data paths 318 per INT32 value, etc.). Data alignment can be accomplished by the compiler or through an application programming interface (API).

In some instances, each stream can have one or more “valid/empty” bits precisely tracking the stream's load-to-use time beyond which the stream is considered logically dead and no longer propagated, which can achieve a reduction in power consumption of the TSP 1001.

### The Instruction Control Unit

Some instructions in the ICUs 1014 can be common to all functional slices 1002. As such, the instructions can contain common instructions like NOP and Repeat, and synchronization instructions Sync and Notify to allow the functional slices 1002 to be initially synchronized, so a compiler can accurately determine instruction execution times and allow cooperative parallelism among the functional slices. ICUs 1014 can retrieve pages of instructions in the MEM partitions, sending Ifetch instructions across side channels in the memory slices, and receiving the instructions from memory back along the same side channel.

The ICUs 1014 can provide explicit instruction fetching for the slices with the Ifetch instruction, and inter-slice synchronization using the Sync and Notify instructions to perform a chip-wide barrier synchronization among participating functional slices. A repeated-NOP (no-op) instruction can allow for precise cycle-by-cycle control of inter-instruction delay. For example, a compiler can have cycle-accurate control when scheduling two operations A and B using an intervening NOP so that N clock cycles separate the operations A and B, i.e., Operation A then NOP(N) then Operation B.

A compiler can use explicit NOPs to provide temporal separation between two instructions in the program order. A NOP can have a repeat count 16-bit field which allows one NOP to wait between 1 ns and 65 us for a 1 GHz clock frequency. A compiler can use NOP instructions to control relative timing of the functional slices 1002 and data on which the functional slices operate. A repeated NOP can be implemented in the ICU 1014 and can be common to all functional slices 1002. While a NOP instruction can be the most common instruction, the NOP instruction may not be included in the specification for a machine learning model, but rather may be inserted into the instructions generated from the model by a compiler.

In some instances, a vector functional slice 1010 can include a central vector functional slice 1010 containing 16 Arithmetic Logic Units (ALU) per lane. Each ALU can perform, for example, a 32-bit calculation using aligned groups of four stream bytes as operands. In addition to the usual arithmetic and logical operations of some conventional ALUs, ALUs of a vector functional slice 1010 can be configured to convert between integer and floating-point formats. In some instances, a vector functional slice 1010 can be configured to perform some predefined normalization functions such as ReLU and the hyperbolic tangent (tanh) as well as exponentiation and reciprocal square roots, allowing programmers to build their own normalization functions.

In some instances, a tensor streaming processor device 1001 can be organized into a plurality of Superlanes, and a vector functional slice 1010 can implement, for each Superlane, a 4×4 mesh of vector ALUs using the 16 vector ALUs per lane. In some instances, an ALU can be configured to receive 32-bit input operands, wherein each of an ALU's 32-bit input operands are organized along an aligned quad-stream group.

In some instances, a vector functional slice 1010 ALUs can include stateless ALUs, such as ALUs that do not produce condition codes or status flags from the last instruction. For example, in some instances, instead of condition codes or status flags, a vector functional slice 1010 can provide both saturating and modulo variants (add_sat, add_mod and mul_sat, mul_mod) for addition and multiplication, which can allow differing semantics for handling arithmetic exceptions. In some instances, a tensor streaming processor 1001 can support chaining together two or more vector ALUs within each lane, allowing multiple ALU operations to be performed without transferring the intermediate results to main memory, saving a write and subsequent read of each intermediate result. This can in some instances allow for efficient parallel implementations of algorithms for batch normalization, quantization, or more complex activation functions like the leaky ReLU activation function, for example.

In some instances, a matrix functional slice 1009 partition can include a plurality of independent regions (e.g., grids, etc.) of multiply-accumulate modules, such as four independent 320-by-320 grids of multiply-accumulate (MACC) modules. In some instances, each 320 by 320 grid can include 20 16 by 16 sub-grids that each produce a partial-sum/dot product result each cycle and pass the result to an adjacent functional tile 902 for use in its computations. In some instances, an N by N grid can use N streams each with N bytes to install N² parameters (e.g., 8-bit weights (IW), etc.) in each grid on every cycle. Using all 32 streams in each direction can allow weights to be placed simultaneously in multiple matrix functional slice 1009 partitions, loading 409,600 weights (e.g., all weights of some example machine-learning models or model partitions, etc.) on-chip in less than 40 cycles. With weights installed, every cycle the matrix functional slice(s) 1009 can generate a new dot-product (e.g., INT32 dot product, etc.) of input activations with installed weights. The features output from the matrix functional slice(s) 1009 can be accumulated using accumulators on each INT32 or FP32 output stream.

In some instances, a matrix functional slice 1009 can support calculations for multiple numerical formats by combining results from multiple lanes. For example, in some instances, a matrix functional slice 1009 can support both 8-bit integer (INT8), and 16-bit floating point (FP16), by using two 320×320 byte-planes in tandem for the 16-bit floating point results. In some instances, a 320-element sum can be produced for each output with only a single rounding step at the end to convert to INT32 or FP32 results. Matrix functional slice 1009 processing can include, for example, one or more of the following operations (instructions): LW—load weights from data flows (streams) to weight buffer; IW—install weights from data flows (streams) or LW buffer into the 320×320 array; ABC—activation buffer control to initiate and coordinate arriving activations; ACC—accumulate either INT32 or FP32 result from MXM.

In some instances, each MACC unit can have two 8-bit weight registers and two 32-bit accumulators. On each cycle, each MACC unit can multiply the stored weight values by a pair of activation values from the streaming data. In some instances, each 16×16 sub-grid can compute an integer partial sum in one cycle and a complete 320-element fused dot-product in 20 cycles. In some instances, a MACC unit can instead operate as a single FP16 MACC, but these operations can require two cycles, reducing throughput by 75% relative to INT8 operations. In some instances, each matrix functional slice 1009 partition can have 320×320 MACC units producing 409,600 INT8 operations or 102,400 FP16 operations per cycle. Using all 32 streams in each direction, the TSP can load all 409,600 weight registers in less than 40 cycles.

The permute/routing functional slice(s) 1011 (sometimes referred to herein as switch units, ‘SXM’ or ‘NET’) can execute functions for the transposition, permutation, shifting and rotation of data elements. Collectively, these operations can be used for performing tensor reshape operations, such as tensor reshape operations associated with one or more machine learning operations. For example, in some instances, a permute/routing functional slice 1011 can rotate or transpose a stream of data across the lanes. In some instances, a permute/routing functional slice 1011 can duplicate bytes to fill a vector or zero any of the vector elements to pad values. In some instances, permute/routing functional slice 1011 can be the only tiles of a processor device 1011 that communicate between Superlanes. Further details of some example permute/routing functional slices 1011 are disclosed in U.S. Pat. No. 10,754,621, incorporated herein by reference.

Data movement on-chip can be carried out by routing data along one or more pathways, such as pathway(s) where data is transferred between SRAM and functional modules within each Superlane, and pathway(s) where the permute/routing functional slice 1011 transfers data across lanes using two sets of lane shifters. The lane-shifters can in some instances be allocated in pairs to facilitate shifting a vector between a lane and its two adjacent lanes in a Superlane. Additionally, in some instances, the permute/routing functional slice 1011 can provide a permute instruction that uses a programmed bijection to remap a plurality of lanes (e.g., 320 lanes, etc.) onto a set of similarly indexed streams, one per Superlane.

In some instances, permute/routing functional slice 1011 can include one or more distributor slices. For example, a distributor slice within a permute/routing functional slice 1011 can be used to arbitrarily remap a plurality of (e.g., 16) lanes within each Superlane. As streams pass through the SXM's distributor, they can be remapped at full bandwidth, or zero-fill any or all of the 16 elements. This can provide an efficient mechanism for common tensor operations like zero padding or rearranging elements of a convolutional neural network filter (e.g., 4×4 filter, etc.).

An example operation on tensor data types can include transposition. In some instances, a TSP 1001 can support a two-dimensional transpose of 256 elements organized as 16 streams each with 16 elements. A transpose operation can take 16 incoming streams and produce 16 output streams with the rows and columns exchanged. This allows the efficient movement of data from the atomic 16-byte MEM word into 16 different MEM slices where they are now addressable. In some instances, a TSP 1001 can include two instances of the SXM on-chip, one in each hemisphere. Each can issue, for example, two (2) transpose instructions, yielding a maximum of four (4) simultaneous transpose 16×16 operations.

In some instances, a tensor streaming processing device 1001 can have a plurality of memory partitions (e.g., two partitions, etc.) each having 44 memory functional slices 1007 comprising ECC-protected SRAM, with each slice comprising 20 tiles that provide a total capacity of 2.5 MiBytes (wherein a Mibyte is 1048576 bytes) per slice, giving the two MEM partitions a total capacity of 220 MiBytes. Each memory functional slice 1007 can include, for example, at least two sets of memory cells referred to as ‘banks’. Each MEM slice can include pseudo-dual-port SRAMs that can service a pair of read and write requests simultaneously, assuming they are not targeting the same bank. In such instances, the 88 memory functional slices 1007, each with 2 banks, can enable up to 176-way memory concurrency to read operands to or store results from streams. Banks of memory not being used can have their power reduced to reduce energy usage.

In some instances, the memory functional slices 1007 can be configured to provide sufficient memory concurrency to supply a target number (e.g., 32, etc.) of operands per lane, every cycle. For example, in some instances 88 slices having 176-way memory concurrency can provide sufficient concurrency to supply 32 operands per lane each cycle. In some instances, memory functional slices 1007 can be partitioned into 16-word bytes, each word distributed across a Superlane, and each byte of each word processed by one lane of the Superlane. In some instances, a memory functional slice 1007 can perform two 16-byte reads and two 16-byte writes per cycle, as long as they access different banks, allowing it to both source and sink data in two directions across all lanes in a Superlane.

In some instances, on-chip memory can supply operands for each functional slice 1002 by reading an address from a memory (MEM) functional slice 1007, denoted MEMᵢ. In some embodiments, slices in each memory can be numbered 0 to 43, with MEM₀ closest to the vector functional slice 1009 and MEM₄₃ nearest to the permute/routing functional slice 1011.

In some instances, memory partitions can enable the programming abstraction of a partitioned global shared address space with the address space laid out uniformly across the slices. In some instances, each memory functional slice 1007 can support both direct and stream-indirect addressing modes. Read and Write operations can use direct addressing, since the address is fully specified in the instruction itself. Indirect addressing can use the contents of a stream, s, to specify an address map for a Gather or Scatter. With indirect addressing, the physical address can be transmitted within the stream value, providing a layer of indirection in the memory referencing.

In some instances, each memory functional slice 1007 can have two dedicated dispatch paths, one for each port of the pseudo-dual-ported SRAM. Each memory instruction can undergo an additional address generation stage for strided references by computing the address aᵢ from the previous address aᵢ₋₁ and strides so that aᵢ=aᵢ₋₁+s between locations. Strided memory references can be accomplished using a sequence of countdown, step, and iters MEM instructions. For example, the following example assembly-language snippet, explicitly schedules read and write instructions at program time t=10 to iterate starting at address 0x1000, striding by 24 on each iteration, for 112 total vectors, as shown in the example below for MEM West slice 43.

```
.MEM West 43
.read
10: read 0x1000, S_0_e
  step 24
    iters 111
.write
10: write 0x00ff, s_16_w
  step 1
  iters 111
```

This iteration mechanism in the address generation circuitry can support for example, multiple levels (e.g., up to four-levels, etc.) of nested iteration allowing for multi-dimensional arrays to efficiently encode tensors as a short sequence of read or write, or gather or scatter, operations followed by countdown, step, and iter instructions to control the loop bounds. The countdown instruction can specify an inter-loop delay in cycles.

As a non-limiting illustrative example, consider a TSP 1001 having a 1 GHz operating frequency of the TSP 1001 clock. The stream register bandwidth, B, exported by each MEM interface on the East and West edge of each MEM partition can keep the functional modules adequately fed with data operands in order to saturate the peak arithmetic capacity of the functional modules. The stream registers can provide a combined capacity of 20 TiB/s of read (operand) and write (result) bandwidth (a Tib is a Mibyte of Mibytes).

To maximize stream concurrency, a compiler can allocate memory for concurrent stream operands associated with a single tensor into separate memory functional slices 1007. For example, as the streams propagate through the MEM system they can “pick up” the arguments from a plurality of separate memory functional slices 1007 enroute to one or more other functional slices 1002 (e.g., matrix functional slices 1009, etc.). In some instances, a compiler can explicitly schedule individual banks of each MEM slice to achieve fine-grain memory management. This can enable design patterns and use-cases where simultaneous reading of operands from one bank and writing of results to the other bank in the same memory functional slice 1007. As an example, a transpose instruction can take 16 input streams and produce 16 output streams with the rows and columns transposed. By using the bank concurrency available within each memory functional slice 1007, it is possible to use the pseudodual-ported SRAM for dual read/write accesses per memory functional slice 1007.

In some instances, a TSP 1001 can include a memory system that is unlike a memory system of a conventional central processing unit (CPU). For example, some conventional CPUs may rely on a memory hierarchy to implicitly move data between caches to service load/store operations. Cache hierarchies can introduce a reactive agent in the data path and can introduce undesired unpredictability, or non-determinism, in the data path to provide the illusion of sequentially consistent memory transactions within the memory hierarchy.

In some instances, a TSP 1001 can differ from a conventional CPU memory by providing a memory management layer that identifies the memory concurrency on an operation by operation basis. As an example, the Python code below shows memory management for an example transpose operation; an instruction that takes 16 streams as input and creates 16 streams of output. The g.malloc function returns a tensor of addresses allocated across 16 memory slices, one for each concurrent stream:

```
# Read from 16 slices onto 16 slices
# Transpose data
# Write from 16 slices into 16 slices
Import groq as g
tensor = g.random_tensor(shape=[1024, 320],
  dtype=g.Int8, layout=[64, 16])
streams_16 = tensor.read(streams=range(16))
streams_16_t = g.transpose16(streams_16)
out_addrs = g.malloc(shape=[1024, 320],
    layout=[64, 16])
streams_16_t.write(out_addrs)
```

In some instances, the memory functional slices 1007 can store very long instruction word (VLIW)-like instructions, such as instructions that are 2,304 (144×16) bytes wide. In some instances, a program can fetch instructions when the memory functional slices 1007 are otherwise idle. For example, in some implementations, instruction fetches can require less than 10% of the total memory bandwidth of the memory functional slices 1007. Instructions can be decoded and loaded into queues, allowing the program to prefetch. To reduce code size, a REPEAT N instruction can repeat a previous instruction N times. In some instances, a program can specify a NOP instruction to last for N cycles.

Each functional slice 1002 can have a predefined set of instructions (e.g., Read, Write, Add, Mul, etc.) that define its supported operations. Furthermore, functional slices 1002 can consume operands from, and produce results to, streams. A more complex sequence of operations, a microprogram, can be composed of one or more slices 1002 coordinating in a producer-consumer manner to create one or more output streams. This can be accomplished by logically chaining multiple slices 1002 together to consume input data from up-stream slices 1002, operate on that data to produce a new result stream, where it later can be consumed by a down-stream slice 1002 in a similar manner. In some instances, each functional slice 1002 can choose a direction of its result stream. With this cooperative producer-consumer model operating on data streams, more elaborate operations can chain together different functional slices 1002, for example, where a composite function, F(x, y, z)=MEM(x)→SXM(y)→MXM(z), is an amalgam of several functional slices 1002 chained together.

This dataflow composition exploits ‘data flow locality’ by passing the same data across multiple functional slices 1002 which can operate on the data to produce some output stream. The output from one functional slice 1002 can be transferred to the input of another slice 1002 allowing for chaining of operations through a common stream register.

In some instances, the underlying data type supported by a TSP 1001 can be a vector. For example, in some instances, number of elements in each vector can vary from 16 elements, one Superlane, all the way to 320 elements using all 20 Superlanes on-chip. That is, the minimum vector length, or minVL, can be 16 bytes and the maximum vector length, or max VL can be a 320 byte-sized element array. Because the vector length can vary from 16 to 320 elements, instructions can configure each tile for a low-power mode to effectively power down any unused Superlane (row of the mesh) and reduce the power consumed. This scalable vector approach allows the vector length to grow from 16 to 320 bytes in 16-lane steps, powering-down the unused tiles, yielding a more energy-proportional system.

In some instances, an instruction set architecture of a TSP 1001 can provide temporal information about each instruction to allow a compiler precise control of each instruction's dispatch time. For example, in some instances, each instruction can be augmented with one or more of the following temporal parameters:

dfunc functional delay—each instruction requires 1 or more cycles to produce its stream output. A functional delay timing parameter can allow the compiler to reason about when the output of an instruction will be available on the architecturally-visible stream registers.

dskew instruction-operand skew—the timing relationship between the instruction dispatch time relative to when its stream operands are required. An instruction-operand skew parameter on each instruction can inform a compiler how to schedule the operand arrival times with the instruction dispatch time in order to get them to properly intersect in time and space.

Such parameters can be useful to track the exact spatial relationship between instructions and operands.

In some instances, a programming model for a TSP 1001 can include, for example, the following two elements: (1) scheduling specific data paths in hardware, and (2) exposing temporal information about an instruction's execution latency through the Instruction Set Architecture (ISA), so that the compiler's back-end can precisely track the position and time-of-use of any stream on-chip.

A compiler can use NOP instructions to control the relative timing of the functional slices 1002 and the data on which they operate. A NOP can have, for example, a repeat count 16-bit field which allows one NOP to wait from Ins up to 65 us for a 1 GHz clock. The NOP instruction can be implemented in the ICU's tile and can be common to all functional slices. The NOP can allow the slice to turn off the clock when performing no operations for anything longer than a few cycles (i.e., n>4 cycles).

Each functional slice 1002 can be independent; however, the compiler can keep track of a logical program time. Conceptually this can be similar to a program counter in a conventional CPU, except the compiler can track the state of a plurality of (e.g., 144, etc.) independent program queues on a cycle-by-cycle basis. So, at logical time t the compiler can know the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional slices 1002 on a chip can be enabled in order to reason about program correctness. For example, in some instances, Sync and Notify instructions can provide a barrier synchronization mechanism across all independent queues on the TSP 1001. One IQ can be designated as a notifier configured to issue a Notify instruction while all other IQs can be parked on a Sync instruction. The receipt of a Notify can be broadcast to all the IQs to satisfy the pending Sync and begin processing instructions again.

This barrier synchronization can be performed, for example, only once after the TSP 1001 resets. However, in practice, some programs may start with a set of “preamble” instructions which configure each tile. After that a Sync instruction can be performed to ensure that all functional slices are aligned to the same logical time. In some example embodiments, a chip-wide barrier synchronization can be accomplished in 35 clock cycles, from the time a Notify is issued to the time a Sync is satisfied and retired to allow subsequent instructions to flow. After this barrier synchronization, the functional slices 1002 can compute and communicate results in a synchronization-free manner through the stream registers.

Repeat (n, d) is an ICU instruction issued to repeat a previous instruction n times, with d cycles between each iteration. Allowing variable amounts of delay between iterations can allow a compiler to temporally align the repeated instruction with its operands in-flight. This simple but flexible iteration mechanism can allow vector functional slices 1010 and matrix functional slices 1009, which are often highly iterative, to encode their instructions more efficiently by making better use of main memory and reducing the number of Ifetch instructions compared to if the loop were unrolled.

An Ifetch instruction can have a single stream operand which carries the instructions in their program order, filling an instruction queue with, for example, 640-bytes (e.g., a pair of 320-byte vectors) of instructions. In some instances, all functional slices 1002 can fetch instructions simultaneously with normal instruction execution. In some instances, a compiler can perform omniscient prefetching of the program's instructions to keep all 144 IQs busy on each cycle by inserting Ifetch instructions into every slices' instruction stream. In some instances, a TSP 1001 or compiler can include a mechanism to ensure that IQs never are empty so that a precise notion of ‘logical time’ is maintained across the processor.

In some instances, a TSP 1001 can be configured to transmit data along a stream without packet routing, arbitration, or the like. For example, on each tick of the core clock, the TSP 1001 can propagate stream values by one stream register hop. The TSP 1001 hardware can, for example, propagate stream values without tracking the origin or destination slice, such as by allowing streams to simply propagate until they fall off the edge of the chip or are overwritten by a functional slice 1002. In some instances, a TSP 1001 can use stream registers within each memory functional slice 1007 to move data along a Superlane, and can use one or more permute/routing functional slices 1011 to move data between Superlanes. An instruction can specify one or more source streams-direction pairs, and a target stream and output direction for the result, effectively providing direction routing of the stream data.

In some instances, a network of TSP 1001 processors can be connected via Chip-to-Chip (C2C) modules 1012. The processors 1001 can logically behave as if all chips share a common clock and are connected via time multiplexed wires. TSP 1001 chips connected via C2C 1012 do not need to share a clock; reasonable alignment of the frequency of the clocks (measured in PPM) can suffice. In some instances, receive buffers in the communications modules can be large enough so that the expected PPMs of clocks don't require a realignment more than once per millisecond, or otherwise don't require realignment often enough to cause difficulty in scheduling between model executions.

In some instances, C2C modules 1012 can either provide sufficient Forward Error Correction for data transfer between chips such that unrecoverable errors will occur <1 per week per chip when using all C2C links, or provide software with a mechanism to add additional redundancy so that errors will occur <1 per week per chip when using all C2C links 1012. If error rates are lower at a lower transfer rate (e.g. 16 Gb/s), then SerDes can be configured to run at a lower rate for improved precision.

Transfers of data between TSP chips 1001 during a compute phase of a program can be supported, e.g. while COMPUTE[i]. CHIP[A] is running on chip A, it may send data to COMPUTE[i].CHIP[B] on chip B, which may result in data being returned to COMPUTE[i].CHIP[B] and used before the computation completes. This can differ, for example, from some PCIe 1013 implementations, which may only allow data to be transferred before and after a COMPUTE phase.

In some instances, each C2C 1012 SerDes of a TSP 1001 can be an independent link, e.g., each link may be the only connection to another device or may be one of multiple connections to another device. Multi-chip systems can be implemented in a variety of topologies for flexible packaging and deployment in rack-scale and cluster scale systems. Communication can occur in a pair-wise manner between a sender port and a receiver port. A sender can perform a MEM read to read an address a onto a stream heading toward a permute/routing functional slice 1011. The permute/routing functional slice 1011 can perform a Send on the C2C unit 1012 representing the physical port where the data is transmitted. On the other side of the link, after a fixed delay for time-of-flight on the wire, the TSP 1001 performing the Receive instruction can pull, for example, a 320-byte vector off the channel for every Receive issued.

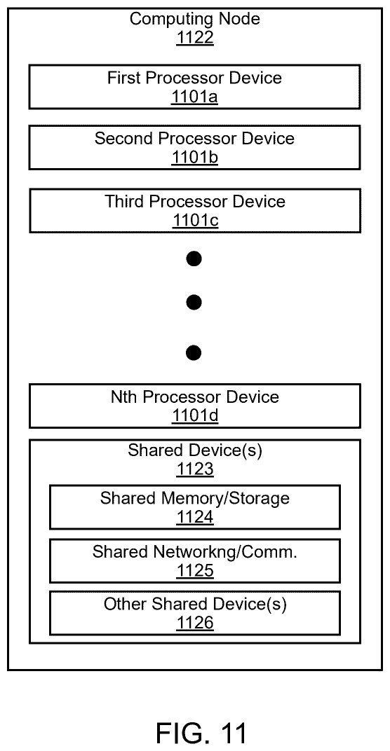

FIG. 11 is a block diagram of an example computing node 1122 according to example implementations of aspects of the present disclosure. A computing node 1122 can include a plurality of processor devices 1101a, b, c, . . . n and one or more shared devices 1123 that are shared between two or more processors 1101 of the plurality of processors 1101. For example, in some instances, shared device(s) 1123 can include one or more of: one or more shared memory or storage devices 1124; one or more shared networking or communication devices 1125; or other shared devices 1126.

A processor device 1101 can have, for example, any property described herein with respect to a processor device 801, 901, or 1001.

A shared device 1123 can include, for example, any device providing one or more functions (e.g., storage functions, communication functions, etc.) to a plurality of processor devices 1101.

A shared memory or storage device 1124 can have, for example, one or more properties that are similar to or different from one or more properties of an external memory module 920. A shared memory or storage device 1124 can include one or more components for reading, writing, or storing various kinds of data, such as operand data, instruction data, or other data. For example, in some instances, a shared memory or storage device 1124 can include non-volatile memory such as one or more solid state drives (SSDs) or other non-volatile storage. As a non-limiting illustrative example, a GroqNode computing node 1122 can include a plurality of processor devices 1101 (e.g., eight TSPs 1001, etc.) and one or more shared SSD cards for non-volatile storage. As another example, in some instances, a shared memory or storage device can include one or more shared external memory modules 920 that may be shared between a plurality of processor devices 1101.

Shared networking/communication devices 1125 can include, for example, any device configured to provide one or more communication functions (e.g., internode communication functions, intra-node communication functions) to one or more processor devices 1101, such as one or more network interface controllers, Ethernet communication devices, routers, modems, communication ports, communication channels, or other communication devices. As a non-limiting illustrative example, in some instances, a GroqNode computing node 1122 can include one or more network interface controller (NIC) cards configured to provide networking functions for the compute node 1122 or processors 1101 thereof.

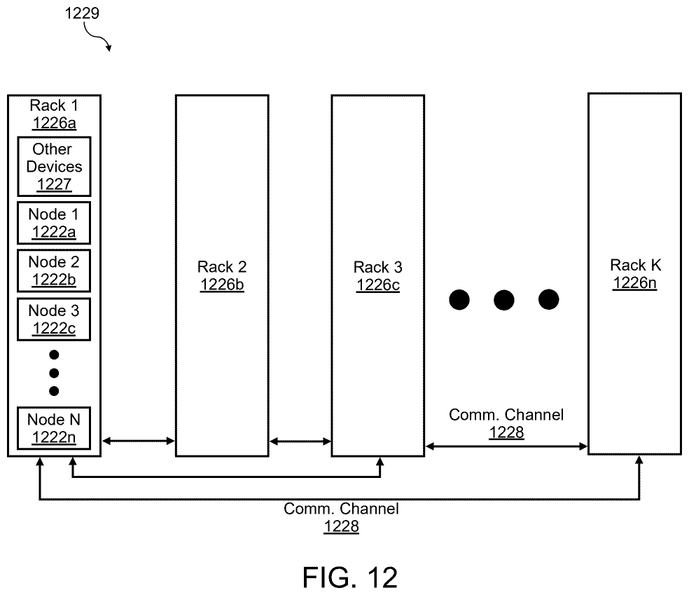

FIG. 12 is a block diagram of an example multi-node computing system 1229 according to example implementations of aspects of the present disclosure. A computing system can include, for example, a plurality of racks 1226a, b, c, . . . n, with each rack holding a plurality of computing nodes 1222 (e.g., computing nodes 1222, b, c, . . . n etc.) and one or more other devices 1227, such as top-of-rack device(s) 1227 or the like. The computing system can further include a plurality of communication channels 1228, each communication channel 1228 connecting one or more nodes of a first rack 1226 to one or more nodes of a second rack 1226.

In some instances, a computing node 1222 can be, comprise, be comprised by, or otherwise share one or more properties with a computing node 1122. For example, in some instances, a computing node 1222 can have any property described herein with respect to a computing node 1122, and vice versa.

A rack 1226 can include, for example, a structure (e.g., server rack, cabinet, etc.) configured to contain a plurality of compute nodes 1222. In some instances, a rack 1226 can include a standard-sized rack for holding server computing devices, and each of a plurality of compute nodes 1222 can include a standard-size compute node for being inserted into a server rack, such as a one-rack-unit (1U), 2U, or 4U node, or other standard compute node size.

Other device(s) 1227 can include, for example, one or more shared devices configured to provide one or more functions to a plurality of compute nodes 1222. In some instances, other device(s) 1227 can include one or more communication devices, such as top-of-rack communication devices. Top-of-rack communication devices can include, for example, a top-of-rack switch; patch panel; routing panel; retimer; or other communication device.

Communication channels 1228 can include various kinds of communication channels, such as electrical communication channels (e.g., conductive wiring such as copper, etc.), optical communication channels (e.g., fiber optic strands, cables, etc.), or other communication channel type. In some instances, communication channels 1228 can include communication channels 1228 between top-of-rack communication devices 1227 (e.g., Ethernet communication channels, etc.); direct chip-to-chip communication channels 1228 between a first processor device 801 of a first rack 1226 and a second processor device 801 of a second rack; direct node-to-node communication of a first shared communication device 1123 of a first node 1122 of a first rack 1226 and a second shared communication device 1123 of a second node 1122 of a second rack 1226; or other communication channel. In some instances, a plurality of communication channels 1228 can form various kinds of communication topologies, such as high-radix topologies wherein each of a plurality of processor devices 801 of a plurality of racks 1226 has multiple chip-to-chip communication ports (e.g., greater than or equal to eight, etc.). In some instances, a topology of the communication channels 1228 can include one or more reconfigurable topologies, such as topologies wherein some or all of a plurality of chip-to-chip communication units 1012 are each connected to one or more topology reconfiguration devices, such as one or more switches; patch panels; connectorized fixed-topology routing panels configured to route a plurality of inputs (e.g., plurality of inputs associated with a multi-strand fiber optic connector, etc.) to a plurality of outputs according to a predetermined topology, thereby enabling rapid switching between topologies by disconnecting from a first fixed-topology routing panel and connecting to a second fixed-topology routing panel.

In some instances, communication channels 1228 can include or be coupled to various communication components, such as communication ports, connections, interface units, or the like; routing or data permutation components (e.g., internal routing or permutation components such as switching components; external components coupled to the processor device 801 such as routers, repeaters, switches, panels, or the like); communication lines (e.g., electrically conductive signal traces, electrically conductive wires, optical fibers, cables, etc.); or other components configured to facilitate one or more communication operations.

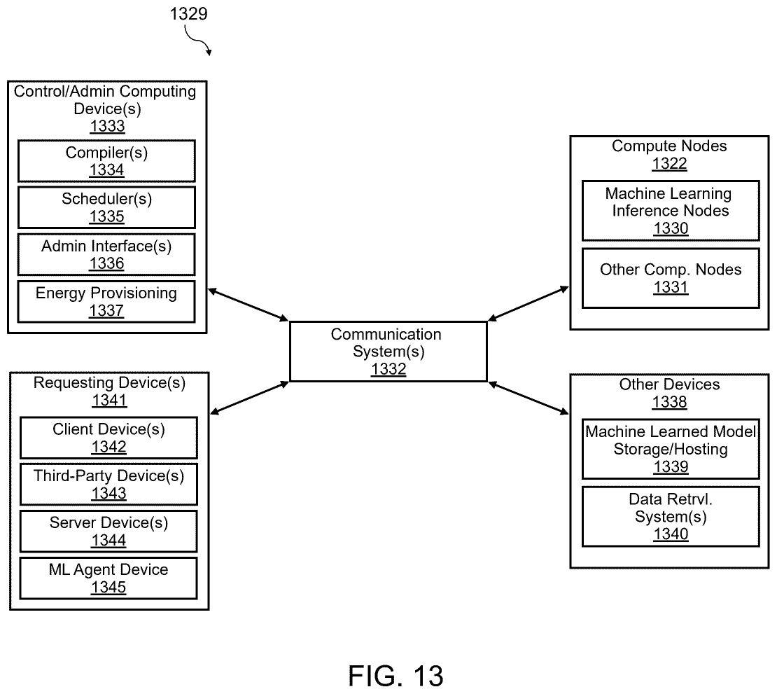

FIG. 13 is a block diagram of an example multi-node computing system 1329 according to example implementations of aspects of the present disclosure. The computing system can include, for example, a plurality of compute nodes 1322 (e.g., machine learning inference nodes 1330, other compute nodes 1331, etc.) in communication with one or more other devices via one or more communication systems 1332. For example, in some instances, the computing system 1329 can include one or more control or administration devices 1333 configured to provide control functions for the compute nodes 1322, such as control or administration devices 1333 comprising one or more compilers 1334 configured to generate compiled computer-executable instructions to be provided to the compute nodes 1322; one or more scheduler(s) 1335 configured to schedule one or more operations (e.g., machine learning inference operations) to be performed by the compute nodes 1322; one or more administrative interfaces 1336 configured to enable human control over the compute nodes 1322 or control/admin device(s) 1333; or one or more energy provisioning components 1337 configured to manage or allocate an energy (e.g., electricity, etc.) supply or energy usage for one or more computing operations. In some instances, the computing system 1329 can include one or more other devices 1338, such as one or more machine-learning model storage or hosting devices 1339 configured to store machine-learning model data (e.g., parameter data, compiled computer-executable instruction data, etc.), one or more data retrieval systems 1340 configured for storage and retrieval of other data (e.g., context data for retrieval-augmented generation, etc.), or other devices 1338. In some instances, the compute nodes 1322 or control/admin nodes 1333 can be in communication, via the communication system(s) 1332, with one or more requesting devices 1341, such as client device(s) 1342, third-party device(s) 1343, server device(s) 1344, machine-learning agent device(s) 1345, or other requesting device(s) 1341. Responsive to receiving one or more requests (e.g., machine-learning inference requests, etc.) from one or more requesting devices 1341, the computing system 1329 can cause the compute nodes 1322 to perform one or more operations to satisfy the request(s).

In some instances, a computing node 1322 can be, comprise, be comprised by, or otherwise share one or more properties with a computing node 1122. For example, in some instances, a computing node 1322 can have any property described herein with respect to a computing node 1122, and vice versa.

Machine learning inference nodes 1330 can include, for example, compute nodes 1322 that are configured or adapted (e.g., optimized or nearly optimized, etc.) to perform one or more machine learning inference tasks; compute nodes 1322 that are designated or scheduled to perform one or more machine learning inference tasks; or the like. For example, in some instances, a machine learning inference node 1330 can have one or more processors adapted to machine learning inference tasks, such as processor having one or more properties described herein with respect to processor devices 801, 901, or 1001.

Machine learning inference nodes 1331 can include, for example, compute nodes 1322 that may not be configured or scheduled for performing machine learning inference tasks, such as compute nodes that are scheduled for performing various non-machine-learning tasks, such as cloud computing tasks, software-as-a-service tasks, support tasks to support one or more machine learning inference nodes, interface hosting or other application hosting, computation tasks (e.g., scientific computation, etc.), data storage or retrieval tasks, or other computing tasks.

A communication system 1332 can include, for example, any system configured to provide communication between compute nodes 1322 and other devices, such as a communication network (e.g., Ethernet network, internet network, local area network, etc.), one or more direct (e.g., non-networked, etc.) communication links, or other communication system or device. In some instances, a communication system can include one or more devices or components described herein with respect to communication units 803, communication channel(s) 1228, or other communication components.

A control or administration device 1333 can include, for example, any device (e.g., computing system, etc.) configured to provide one or more control or administration functions to control an operation of one or more compute nodes 1322 (e.g., machine learning inference nodes 1330, etc.). For example, in some instances, a control/admin computing device 1333 can include one or more compilers 1334 or schedulers 1335 configured to control or schedule one or more operations (e.g., machine-learning inference operations, etc.) of a compute node 1322; one or more control functions configured to control various properties (e.g., topology, etc.) of a computing system comprising one or more compute nodes 1322; one or more administrator interfaces 1336 configured to enable an administrator (e.g., human administrator, computer-implemented administrator process, etc.) to select one or more configuration options or control options (e.g., scheduling options, compilation options, etc.); or other control or administration functions (e.g., energy provisioning 1337 functions, etc.).

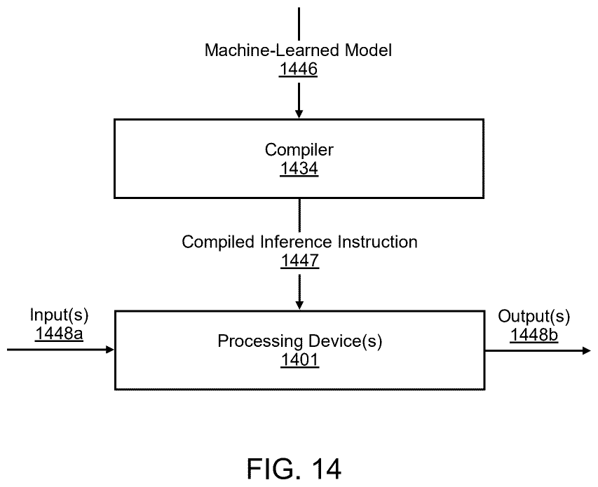

A compiler 1334 can include, for example, a device or process (e.g., process executing on a computing system, etc.) configured to receive data indicative of one or more computing operations (e.g., machine-learning inference operations, etc.) and generate, based at least in part on the data indicative of the one or more computing operations, a set of compiled computer-executable instructions for performing the one or more computing operations. In some instances, a compiler 1334 can include a compiler configured to control a timing of one or more computational operations (e.g., temporal relationship between operations, etc.), such as a compiler configured to control a timing of one or more deterministic operations performed by one or more deterministic processor devices. Further details of some example compilers are provided below with respect to FIG. 14.

A scheduler 1335 can include, for example, a device or process (e.g., process executing on a computing system, etc.) configured to receive data indicative of one or more computing operations (e.g., machine-learning inference operations associated with machine-learning inference requests received from requesting devices 1341, etc.) and determine a schedule for performing the computing operations. For example, in some instances, a scheduler 1335 can allocate the operation(s) to one or more compute nodes 1322; determine a time (e.g., immediately; according to an ordering of operations such as immediately after an earlier-scheduled operation is completed; at a selected time of day, such as a time of off-peak demand; etc.) or other criterion (e.g., threshold number of available compute nodes 1322; priority level of other scheduled computing operations; etc.) for beginning the one or more computing operations; or other scheduling activity. In some instances, scheduling can include determining a number of compute nodes 1322 to perform a given computing operation. In some instances, scheduling can include selecting between a plurality of precompiled sets of compiled instructions for performing a given set of computing operation(s), and causing a set of compute node(s) 1322 to execute the selected set of compiled instructions. For example, in some instances, a machine-learning model can be compiled a plurality of times to generate a plurality of precompiled sets of instructions for performing inference with the machine-learning model, such as precompiled sets for performing inference with different numbers of available compute nodes 1322; with different restrictions on latency, power usage, memory usage, or other runtime constraints; or the like.

An administrator interface 1336 can include, for example, any interface (e.g., user interface such as graphical user interface, application programming interface, etc.) for receiving data indicative of one or more administrative actions or administrative selections, such as configuration option selections (e.g., topology configuration, runtime constraint configuration, etc.), operation scheduling selections (e.g., maintenance operation scheduling, inference request scheduling, etc.), or other administrative selections.

An energy provisioning component 1337 can include, for example, a process or device configured to allocate or provision energy (e.g., electricity, power, etc.) to one or more compute nodes 1322. In some instances, an energy provisioning component 1337 can include one or more power source components, energy storage devices, power regulator devices, or other energy provisioning components. In some instances, an energy provisioning component 1337 can include a power regulator component configured to receive demand data indicative of an amount of power needed (a “demand load”) by one or more load devices at one or more times; and control, based at least in part on the demand data, one or more properties of a supply of power provided to one or more load devices.

In some instances, an energy provisioning component 1337 can include one or more components for determining (e.g., measuring, predicting, estimating, etc.) one or more present or future demand load values, such as a present wattage, expected peak wattage, expected total number of watt hours, or other measure of power demand over a period of time. In some instances, determining one or more future demand load values can include predicting near-term demand load values or long-term demand load values, such as an expected peak demand value or expected cumulative demand value over a time period comprising seconds, minutes, hours, days, or another time period. In some instances, measuring a future demand load (e.g., near-term future demand load, etc.) can include obtaining first data indicative of a plurality of compute operations (e.g., already-scheduled inference jobs, etc.); obtaining second data indicative of an amount of power used by each compute operation (e.g., based on measured power usage data, hardware data, etc.); and determining, based on the first and second data, a future demand load associated with a given time or time period. In some instances, data indicative of an amount of power used by a job can include, for example, hardware data indicative of an amount of power that one or more devices (e.g., processor device(s) 801, etc.) use for each of one or more hardware operations (e.g., hardware operations defined by a compiled instruction set, etc.); instruction data correlating each of one or more compute jobs to a plurality of instructions or operations included in the compute job(s); or other power data. In some instances, predicting a future demand load can include obtaining time series data indicative of past demand loads; and predicting (e.g., using a machine-learning model; using a non-machine-learning algorithm; etc.), based on the time series data, on or more future load values.

In some instances, an energy provisioning component 1337 can include one or more components configured to perform one or more control actions (e.g., energy provisioning adjustments, compute job scheduling adjustments, etc.) based on measured or predicted demand data. In some instances, a control action can include determining or adjusting a schedule of one or more compute jobs, such as determining a time at which a compute job should be performed; allocating one or more devices to the compute job; or other scheduling determination. In some instances, a control action can include determining or adjusting a set of compiled instructions for executing one or more compute operations, such as selecting between a plurality of compiled instruction sets configured to perform a given compute operation with different power usage profiles (e.g., different power usage profiles and different performance characteristics, such as latency characteristics, etc.) In some instances, a control action can include determining or adjusting an energy provisioning schedule, such as increasing or decreasing an amount of power routed to one or more devices (e.g., energy storage devices, processor devices 801, compute nodes 1122, etc.); causing an energy storage device to transmit or receive power; or other energy provisioning action. In some instances, a control action can be based on one or more of short-term (e.g., seconds, minutes, etc.) and long-term (e.g., hours, days, etc.) power prediction data. For example, in some instances, a control action can include an action to control an amount of power routed to an energy storage device during an off-peak period based at least in part on an amount of power drawn or predicted to be drawn from the energy storage device during an earlier or later peak-usage period.

Other devices 1338 can include, for example, any other device (e.g., computing device, storage device, etc.) configured to interact with compute node(s) 1322, such as machine-learning model storage/hosting device(s) 1339 configured to store compiled or uncompiled machine-learning model data and provide the machine-learning model to other devices (e.g., control/admin devices 1333, compute nodes 1322, client devices 1342, etc.), data retrieval system(s) 1340 such as systems storing retrievable context data for retrieval-augmented inference operations (e.g., retrieval-augmented generation, etc.) or the like.

A requesting device 1341 can include, for example, any device configured to transmit one or more computation requests (e.g., inference requests, etc.) to one or more of: one or more compute nodes 1322, one or more control/admin computing devices 1333, or other destination. In some instances, a requesting device 1341 can include a computing device (e.g., computing device comprising one or more processors, memory components, storage components, input/output components, communication components, or the like), communication device (e.g., interface device configured to transmit a request from a user or from another device, etc.), or the like.

A client device 1342 can include, for example, a device associated with a client (e.g., end user, etc.) who may originate an inference request, or who may originate another request or action (e.g., search query, question, chatbot interaction, etc.) that may trigger an inference request (e.g., server-originated inference request, machine-learning agent-originated inference request, etc.). In some instances, a client device can be a computing device, such as a laptop, smart phone, smart glasses, augmented reality headset, gaming console, tablet, desktop, workstation, or other computing device.

A server device 1344 can include, for example, a computing device configured to interact with one or more client devices 1342, third-party devices 1344, or machine-learning agent devices 1345 (e.g., via a network such as the internet). For example, in some instances, a server device 1344 can receive, from one or more client devices 1342, third-party devices 1343, or machine-learning agent devices 1345, a machine-learning inference request identifying an inference operation to be performed, or the server device 1344 can receive another input (e.g., search query, question, chatbot interaction, etc.) and determine, based on the other input, one or more machine-learning inference operations to be performed. The server device 1344 can then provide, for example, an inference request to one or more of: one or more compute nodes 1322, one or more control/admin devices 1333 (e.g., a scheduler 1335, etc.), or the like.

A third-party device 1343 can include, for example, a computing device (e.g., Linux server, etc.) associated with a third party different from a client or end user and different from an operator of the compute nodes 1322.

A machine-learning agent device 1345 can include, for example, a device operating a machine-learning agent configured to output data indicative of one or more inference requests. For example, in some instances, a machine-learning agent can include an agent configured to output one or more natural language inference requests; one or more application programming interface (API) calls or other computer-executable instructions indicative of an inference request; or more specialized tokens indicative of an inference request; or the like. In some instances, a machine-learning agent can include an agent configured to receive an input (e.g., user query, task request, inference request, etc.); and perform a plurality of action selection iterations based on the input (e.g., to perform a requested task or answer a provided question, etc.). For example, a first action selection iteration can include selecting, based on the input, a first action to be performed (e.g., by the machine-learning agent or by another device or process); and obtaining first data indicative of a result of the performed action. A second action iteration can then include selecting, by the machine-learning agent based on the first data indicative of the result of the first action, a second action to be performed; and obtaining second data indicative of a result of the second action. This can be repeated for a plurality of iterations (e.g., indefinitely) until the machine-learning agent selects an ending action (e.g., outputting a final output to an end user, etc.). In some instances, a machine-learning agent device 1345 can include a device having a machine-learning agent configured to select an action from an action space that includes one or more inference request actions to submit an inference request to the compute nodes 1322. In some instances, a machine-learning agent device 1345 can include a third-party device 1343 operated by a different entity (e.g., organization, etc.) compared to the compute nodes 1322, or can be a device (e.g., machine-learning inference node 1330, etc.) operated by an entity that is the same as an entity controlling the compute nodes 1322.

FIG. 14 is a block diagram of an example system for compiling a machine-learning model according to example implementations of aspects of the present disclosure. A compiler 1434 can obtain (e.g., receive, retrieve, etc.) data indicative of a machine-learning model 1446. The compiler 1434, can generate, based on the data indicative of the machine-learning model 1446, one or more compiled inference instructions 1447 configured to cause one or more processor devices 1401 to perform one or more operations (e.g., inference operations, etc.) using the machine-learning model 1446. The compiler 1434 can provide the compiled inference instructions 1447 to the processor device(s) 1401, and the processor device(s) 1401 can execute the compiled inference instructions 1447 based at least in part on one or more inputs 1448a to generate one or more outputs 1448b (e.g., machine-learning inference outputs generated using the machine-learning model 1446, etc.).

In some instances, a processor device 1401 can be, comprise, be comprised by, or otherwise share one or more properties with a processor device 801, 901, 1001. For example, in some instances, a processor device 1401 can have any property described herein with respect to a processor device 801, 901, or 1001, and vice versa.

In some instances, a compiler 1434 can be, comprise, be comprised by, or otherwise share one or more properties with a compiler 1334. For example, in some instances, a compiler 1434 can have any property described herein with respect to a compiler 1334, and vice versa.

In some instances, a compiler 1434 can include a compiler configured to generate compiled inference instructions for one or more deterministic processor devices 1401. For example, in some instances, a compiler 1434 can include a compiler configured to control a timing of one or more (e.g., all, etc.) operations of one or more processor devices 1401 to perform inference using the machine-learning model 1446. In some instances, a compiler 1434 can obtain (e.g., receive, retrieve from memory or storage, etc.) hardware knowledge indicative of various known properties of one or more compilation target processor devices 1401, such as data indicative of a number, type, and location of each of a plurality of components (e.g., functional unit(s) 802, communication links 803, etc.) of the target processor device(s) 1401; data indicative of an amount of time (e.g., number of clock cycles, etc.) that one or more operations may take to complete; or other timing data. In some instances, data indicative of an amount of time an operation may take can include, for example, data indicative of a number of clock cycles a functional unit 802 may take to perform a functional operation; data indicative of a transit time (e.g., number of clock cycles, etc.) for an operand data item to be transmitted from a first component (e.g., functional unit 802, communication unit 803, etc.) to a second component or from a first processor device 1401 to a second processor device 1401; data indicative of a transit time for instruction data to be transmitted from an instruction control unit 814 to a functional unit 802; or other timing data.

In some instances, a compiler 1434 can be configured to schedule, based on the timing data, a plurality of operations (e.g., data transfer operations, functional unit 802 operations, instruction transfer operations, etc.) to cause one or more operands to intersect with one or more instructions at a functional unit 802 for executing the instructions on the operand(s) at a predetermined time instant (e.g., absolute or relative clock cycle value, etc.) selected by the compiler 1434. In some instances, a compiler 1434 can be configured to identify one or more data dependencies (e.g., operations that may receive, as input, an output of a previous operation, etc.) or other prerequisites to one or more operations; and deterministically schedule, based on timing data, a dependent operation at a time when all dependencies of the dependent operation will be satisfied. In some instances, a compiler 1434 can control a timing of various operations of various processor 1401 components (e.g., functional units 802, communication units 803, control unit(s) 804, etc.) in various ways, such as by controlling an order of operations; using one or more delay instructions to cause a processor 1401 to remain idle until a predetermined time for performing a next operation; or the like. A delay instruction can include, for example, a no-operation instruction to perform no operation for one or more clock cycles; an instruction having a delay parameter indicative of a number of clock cycles to wait before or after executing the instruction; or other delay instruction.

In some instances, scheduling one or more operations can include scheduling based at least in part on dependency data. For example, in some instances, a compiler 1434 can identify one or more dependencies (e.g., prerequisite operations, required operand data, etc.) of an operation; determine a completion time at which each dependency will be satisfied; and schedule the dependent operation based on the expected completion time(s). As another example, in some instances, a compiler 1434 can identify a scheduled time at which a dependent operation will be performed, and schedule a start time of one or more prerequisite operations based on the scheduled time and data indicative of a duration of each prerequisite operation. As another example, in some instances, a compiler 1434 can identify a periodicity (e.g., number of clock cycles per operation or set of operations) of a set of repeated operations (e.g., repeated prerequisite operations, etc.) and schedule a related set of repeated operations (e.g., repeated dependent operations, etc.) based on the periodicity (e.g., by scheduling an amount of delay between iterations of the related set of repeated operations, etc.).

In some instances, a duration of one or more operations can include a sum of a one or more time costs (e.g., duration, latency, etc.) of the one or more operations, such as one or more of: a duration or latency of one or more functional operations (e.g., floating-point operations, memory access operations, etc.) of one or more functional units 802; a duration or latency of one or more data transfer operations transferring an output of a prerequisite operation to a functional unit 802 scheduled to perform a dependent operation; or other time cost values. In some instances, scheduling a dependent operation can include determining an expected end time of one or more prerequisite operations (e.g., start time plus duration, etc.); and providing a delay instruction to a functional unit 802 performing the dependent operation to cause the functional unit 802 to execute after any dependencies are satisfied. In some instances, scheduling a prerequisite operation can include determining a latest permissible start time of one or more prerequisite operations (e.g., dependent-operation start time minus prerequisite-operation duration, etc.); and causing the prerequisite operation to be initiated on or before the latest permissible start time. In some instances, scheduling a plurality of operations can include scheduling a plurality of prerequisite operations to cause a plurality of prerequisites to be satisfied simultaneously (e.g., such that a plurality of operands intersect at a given functional unit 802 at a time determined by the compiler 1434, etc.), such as by delaying one or more of the prerequisite operations to synchronize the operations with a latest-finishing prerequisite operation, or the like.

In some instances, a compiler 1434 can be configured to schedule one or more operations, or allocate one or more operations to component(s) (e.g., functional units 802, etc.) for performing the operations, based at least in part on one or more of: an expected latency, an expected level of concurrency, an expected throughput, or other expected performance measure associated with one or more allocations. For example, in some instances, a compiler 1434 can perform one or more memory allocation operations to reduce a latency, increase a level of memory concurrency, or otherwise improve a performance of one or more operations. For example, in some instances, a compiler 1434 can identify a plurality of operand values (e.g., machine-learning model 1446 parameters, etc.) to be used concurrently (e.g., parameters belonging to the same layer or head of a machine-learning model 1446, etc.), and can allocate the plurality of operand values to a plurality of independently accessible memory banks to increase memory concurrency, reduce latency, or otherwise improve performance of a processor device 1401.

In some instances, a compiler 1434 can be configured to deterministically schedule a timing of one or more communication operations or data access operations, such as memory access, chip-to-chip communication operations between two or more processor devices 1401, or the like. For example, in some instances, a compiler can obtain hardware knowledge indicative of a topology of a chip-to-chip communication network; obtain (e.g., receive, retrieve, generate, etc.) data indicative of one or more data transfers to be performed; and allocate one or more communication links 803 for performing the data transfer(s). In some instances, the hardware data can include timing data (e.g., any form of timing data described above, etc.), and the compiler 1434 can control a timing of the data transfer(s) based on the timing data. In some instances, scheduling one or more data transfers can include compile-time routing or compile-time load balancing. For example, in some instances, a compiler 1434 can determine, at compile time, an amount of data associated with a data transfer; and determine, based on the amount of data and a bandwidth of one or more communication links 803, an amount of time required to transmit the data over the communication link(s) 803. In some instances, the compiler 1434 can determine, based on the timing data, a reduced-latency set of data transfer path(s) for transferring the data, and can allocate the data transfer operation to the reduced-latency path(s). For example, in some instances, the compiler 1434 can determine that performing a large data transfer over a small number of minimal data transfer paths (e.g., data transfer paths with a minimal number of hops, minimal latency for a one-byte transfer, etc.) may take a long time due to low collective bandwidth of the minimal data transfer paths; and allocate, at compile time, one or more non-minimal data transfer paths to the data transfer (e.g., in addition to one or more minimal paths, etc.). In some instances, a compiler 1434 can control, based on the timing data, a timing of one or more data transfer operations, such as by controlling a timing of one or more memory accesses to cause a plurality of transferred data items to arrive simultaneously or near-simultaneously (e.g., with a reduced gap between first and last data of a given data transfer or set of concurrent operands, etc.).

A machine-learning model 1446 can include, for example, various kinds of machine-learning model architectures, such as architectures having one or more feedforward layers (e.g., fully connected layers, perceptron layers, etc.), attention layers, convolutional layers, recurrent layers, gating components, structured state space machine layers, or other components. In some instances, a machine-learning model 1446 can include a machine-learning model configured to generate various kinds of outputs, such as classification outputs, generative outputs (e.g., generative language outputs such as natural language or computer code, generative image outputs, video outputs, audio outputs, text outputs, multimodal outputs, etc.), predictive outputs, or other output type. In some instances, a machine-learning model 1446 can be configured to process various input types, such as language, numerical, text, audio, video, image, time series data, or other input type. In some instances, a machine-learning model 1446 can include one or more nodes, each node comprising one or more parametrized operations, each parametrized operation comprising one or more operators and one or more operand parameters.

In some instances, data indicative of a machine-learning model 1446 can include various kinds of data, such as source code data (e.g., TensorFlow source code data, PyTorch source code data, etc.), parameter data (e.g., .safetensors file comprising a plurality of parameter tensors, etc.), operator data, or other data indicative of a machine-learning model 1446.

Operators of a parametrized operation can include, for example, arithmetic operators, matrix transformation operators, Boolean operators, and other operators which take one or more inputs and generate a single output (i.e., functions), including any operators used within a machine learning model on input data. Further examples of specific operators may include multiplication, division, convolution, projection, matrix multiplication, activation functions (e.g., softmax, ReLU, sigmoid, etc.), combination operators (e.g., elementwise addition, pooling, etc.), and so on.

In some instances, parameters of a machine-learning model 1446 can include tensor(s) comprising a plurality of parameter values. Parameter values can include, for example, operands for one or more operations of the machine-learning model 1446 (e.g., operations taking both parameter value(s) and input value(s) as operands, etc.). Parameter values can include, for example, operands that are trained during a training process of the machine-learning model 1446.

Compiled inference instruction(s) 1447 can include, for example, a set of computer-executable instructions (e.g., assembly code, machine code, object code, compiled binary, etc.) configured to cause one or more processor devices 1401 to perform inference using the machine-learning model 1446. In some instances, compiled inference instruction(s) 1447 can include instructions in a format recognized by one or more instruction control units 814 of the processor device(s) 1401; one or more functional units 802 of the processor device(s) 1401; or both.

Inputs and outputs 1448a, b can include, for example, various kinds of data, such as numerical data, text data, language data, image data, audio data, video data, multimodal data, or other data type. In some instances, inputs 1448a can include inputs provided by a user or other entity (e.g., machine-learning agent, etc.) as part of an inference request. In some instances, outputs 1448b can include outputs generated by the machine-learning model 1446 based on the inputs 1448a.

In an aspect, the present disclosure provides a method for error correction in chip-to-chip (C2C) communications for a processor. The method includes generating a deterministic processing schedule assigning a plurality of computation operations among a plurality of functional units, wherein the plurality of functional units are arranged among a plurality of processing units. Additionally and/or alternatively, the method includes receiving, by a first processing unit of the plurality of processing units, a packet from a second processing unit of the plurality of processing units. Additionally and/or alternatively, the method includes detecting an error in the packet. Additionally and/or alternatively, the method includes identifying, based on the deterministic processing schedule, an identified context of a plurality of contexts, the identified context associated with the packet. Additionally and/or alternatively, the method includes altering a value of one or more poison bits in a poison register to indicate that the identified context is poisoned.

In some implementations, the plurality of functional units include a rack configuration, the rack configuration including a plurality of language processing units (LPUs), each LPU including one or more of the plurality of functional units, arranged to communicate over a plurality of C2C communication links.

In some implementations, one or more symbols of the packet are interleaved among the plurality of C2C communication links.

In some implementations, the deterministic processing schedule defines which of the plurality of functional units will perform which of the plurality of computation operations at specified times.

In some implementations, detecting the error in the packet includes detecting an invalid checksum of the packet.

In some implementations, detecting the error in the packet includes detecting an invalid sequence counter value in the packet.

In some implementations, detecting the error in the packet includes identifying that the error is not correctable by a forward error correction (FEC) algorithm.

In some implementations, the packet is smaller than a codeword length of the FEC algorithm; wherein, during execution of the FEC algorithm, the packet is padded with one or more default values such that a length of the packet is equal to the codeword length; and wherein the one or more default values are appended to the packet by the first processing unit subsequent to receiving the packet, such that the one or more default values are not transmitted by the second processing unit.

In some implementations, the method further includes executing the plurality of computation operations according to the deterministic processing schedule for the other contexts of the plurality of contexts; and repeating at least one computation operation of the plurality of computation operations corresponding to the identified context.

In some implementations, repeating the at least one computation operation includes resetting a program cache utilized in the at least one computation operation.

In some implementations, the program cache includes a LLM cache.

In some implementations, the plurality of computation operations define one or more inference tasks associated with one or more users.

In some implementations, the one or more users includes a plurality of users, and wherein the plurality of contexts are respectively associated with the plurality of users.

In some implementations, the one or more inference tasks include evaluating one or more prompts from the one or more users by at least one machine-learning model.

In some implementations, the at least one machine-learning model includes a large language model (LLM).

In some implementations, identifying the identified context of the plurality of contexts includes accessing timing data of the deterministic processing schedule, the timing data associating expected packets with contexts; and identifying the identified context based on the timing data of the deterministic processing schedule.

In some implementations, the method further includes communicating the value of the poison bit to a third processing unit.

In an aspect, the present disclosure provides a system. The system includes a plurality of functional units arranged among a plurality of processing units. Additionally and/or alternatively, the system includes a poison register. Additionally and/or alternatively, the system includes one or more processors. Additionally and/or alternatively, the system includes one or more computer-readable media storing instructions that, when executed, cause the one or more processors to perform operations. Additionally and/or alternatively, the operations include generating a deterministic processing schedule assigning a plurality of computation operations among the plurality of functional units. Additionally and/or alternatively, the operations include receiving, by a first processing unit of the plurality of processing units, a packet from a second processing unit of the plurality of processing units. Additionally and/or alternatively, the operations include detecting an error in the packet. Additionally and/or alternatively, the operations include identifying, based on the deterministic processing schedule, an identified context of a plurality of contexts, the identified context associated with the packet. Additionally and/or alternatively, the operations include altering a value of one or more poison bits in the poison register to indicate that the identified context is poisoned.

In some implementations, identifying the identified context of the plurality of contexts includes accessing timing data of the deterministic processing schedule, the timing data associating expected packets with contexts; and identifying the identified context based on the timing data of the deterministic processing schedule.

In an aspect, the present disclosure provides a method. The method includes generating characterization data for a C2C communication link of a system including a plurality of processing units and a plurality of functional units, the C2C communication link coupling at least two of the plurality of processing units. Additionally and/or alternatively, the method includes generating a deterministic processing schedule assigning a plurality of computation operations among the plurality of functional units. Additionally and/or alternatively, the method includes identifying, based on the deterministic processing schedule, a data transfer operation of the plurality of computation operations, the data transfer operation occurring along the C2C link. Additionally and/or alternatively, the method includes, based on the characterization data, assigning an error correction scheme of a plurality of candidate error correction schemes to be applied to the data transfer operation in the deterministic processing schedule.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method for error correction in chip-to-chip (C2C) communications for a processor, the method comprising:
generating a deterministic processing schedule assigning a plurality of computation operations among a plurality of functional units, wherein the plurality of functional units are arranged among a plurality of processing units;
receiving, by a first processing unit of the plurality of processing units, a packet from a second processing unit of the plurality of processing units;
detecting an error in the packet;
identifying, based on the deterministic processing schedule, an identified context of a plurality of contexts, the identified context associated with the packet; and
altering a value of one or more poison bits in a poison register to indicate that the identified context is poisoned.

2. The method of claim 1, wherein the plurality of functional units comprise a rack configuration, the rack configuration comprising a plurality of language processing units (LPUs), each LPU comprising one or more of the plurality of functional units, arranged to communicate over a plurality of C2C communication links.

3. The method of claim 2, wherein one or more symbols of the packet are interleaved among the plurality of C2C communication links.

4. The method of claim 1, wherein the deterministic processing schedule defines which of the plurality of functional units will perform which of the plurality of computation operations at specified times.

5. The method of claim 1, wherein detecting the error in the packet comprises detecting an invalid checksum of the packet.

6. The method of claim 1, wherein detecting the error in the packet comprises detecting an invalid sequence counter value in the packet.

7. The method of claim 1, wherein detecting the error in the packet comprises identifying that the error is not correctable by a forward error correction (FEC) algorithm.

8. The method of claim 7, wherein the packet is smaller than a codeword length of the FEC algorithm;
wherein, during execution of the FEC algorithm, the packet is padded with one or more default values such that a length of the packet is equal to the codeword length; and
wherein the one or more default values are appended to the packet by the first processing unit subsequent to receiving the packet, such that the one or more default values are not transmitted by the second processing unit.

9. The method of claim 1, further comprising:
executing the plurality of computation operations according to the deterministic processing schedule for the other contexts of the plurality of contexts; and
repeating at least one computation operation of the plurality of computation operations corresponding to the identified context.

10. The method of claim 9, wherein repeating the at least one computation operation comprises resetting a program cache utilized in the at least one computation operation.

11. The method of claim 10, wherein the program cache comprises a LLM cache.

12. The method of claim 1, wherein the plurality of computation operations define one or more inference tasks associated with one or more users.

13. The method of claim 12, wherein the one or more users comprises a plurality of users, and wherein the plurality of contexts are respectively associated with the plurality of users.

14. The method of claim 12, wherein the one or more inference tasks comprise evaluating one or more prompts from the one or more users by at least one machine-learning model.

15. The method of claim 14, wherein the at least one machine-learning model comprises a large language model (LLM).

16. The method of claim 1, wherein identifying the identified context of the plurality of contexts comprises accessing timing data of the deterministic processing schedule, the timing data associating expected packets with contexts; and
identifying the identified context based on the timing data of the deterministic processing schedule.

17. The method of claim 1, further comprising communicating the value of the poison bit to a third processing unit.

18. A system, comprising:
a plurality of functional units arranged among a plurality of processing units;
a poison register;
one or more processors; and
one or more computer-readable media storing instructions that, when executed, cause the one or more processors to perform operations, the operations comprising:
generating a deterministic processing schedule assigning a plurality of computation operations among the plurality of functional units;
receiving, by a first processing unit of the plurality of processing units, a packet from a second processing unit of the plurality of processing units;
detecting an error in the packet;
identifying, based on the deterministic processing schedule, an identified context of a plurality of contexts, the identified context associated with the packet; and
altering a value of one or more poison bits in the poison register to indicate that the identified context is poisoned.

19. The system of claim 18, wherein identifying the identified context of the plurality of contexts comprises accessing timing data of the deterministic processing schedule, the timing data associating expected packets with contexts; and
identifying the identified context based on the timing data of the deterministic processing schedule.

20. A method, comprising:
generating characterization data for a C2C communication link of a system comprising a plurality of processing units and a plurality of functional units, the C2C communication link coupling at least two of the plurality of processing units;
generating a deterministic processing schedule assigning a plurality of computation operations among the plurality of functional units;
identifying, based on the deterministic processing schedule, a data transfer operation of the plurality of computation operations, the data transfer operation occurring along the C2C link; and
based on the characterization data, assigning an error correction scheme of a plurality of candidate error correction schemes to be applied to the data transfer operation in the deterministic processing schedule.
